(19) United States
(12) Patent Application Publication
(10) Pub. No.: US 2011/0027665 A1
(43) Pub. Date: Feb. 3, 2011

(54) AIR ELECTRODE WITH BINDER MATERIALS AND MANUFACTURING METHODS FOR AIR ELECTRODE

(75) Inventors: Trygve Burchardt, Mannedorf (CH); James P. McDougall, Maennedorf (CH); Maria J. Sedda, Maennedorf (CH)

Correspondence Address: FOLEY & LARDNER LLP, 777 EAST WISCONSIN AVENUE, MILWAUKEE, WI, 53202-5306, US

(73) Assignee: ReVolt Technology Ltd.

(21) Appl. No.: 12/847,890

(22) Filed: Jul. 30, 2010

Related U.S. Application Data
(60) Provisional application No. 61/230,550, filed on Jul. 31, 2009.
(60) Provisional application No. 61/304,273, filed on Feb. 12, 2010.

(51) Int. Cl. H01M 8/22

(52) U.S. Cl. 429/405; 264/104

(57) ABSTRACT

A method of producing all or a portion of an air electrode for a metal-air battery includes forming at least a portion of the air electrode using a process selected from the group consisting of an injection molding process and a screw extrusion process. This process may be used to form a gas diffusion layer of the air electrode, and active layer of the air electrode, or both. The air electrode may use polyethylene and/or polypropylene as a binder material in all or a portion of the air electrode.

### CROSS-REFERENCE TO RELATED PATENT APPLICATIONS

The present application claims priority to and the benefit of U.S. Provisional Patent Application No. 61/230,550, filed Jul. 31, 2009, and U.S. Provisional Patent Application No. 61/304,273, filed Feb. 12, 2010, the entire disclosures of which are incorporated herein by reference.

### BACKGROUND

The present application relates generally to the field of batteries and components for batteries. More specifically, the present application relates to the use of processes, materials, and structures/components to manage the interaction between the internal chemical reaction in a metal-air battery and the external environment. The concepts disclosed herein are further applicable to metal-air fuel cells.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the negative electrode (anode) and the positive electrode (cathode).

On discharging metal-air batteries, oxygen from the atmosphere is converted to hydroxyl ions in the air electrode. The hydroxyl ions then migrate to the metal electrode, where they cause the metal of the negative electrode to oxidize. The desired reaction in the air electrode involves the reduction of oxygen, the consumption of electrons, and the production of hydroxyl ions. The hydroxyl ions migrate through the electrolyte towards the metal electrode, where oxidation of the metal occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

A metal-air battery is a partially open system, where the air electrode interacts with the environment. While a metal-air battery utilizes oxygen from its surrounding environment, it may also be limited by other elements/factors of its surrounding environment. Environmental elements/factors such as humidity and the presence of carbon dioxide (CO₂) can significantly shorten the lifespan of metal-air batteries, in many cases limiting their possible applications.

Air electrodes for metal-air batteries typically include a binder that is used to bind the components of the air electrode (e.g., carbon materials, catalysts, other pore forming materials, etc.) together. For example, polytetrafluoroethylene (PTFE) has previously been used as a binder in pastes used to form air electrodes. One issue associated with the use of PTFE, for example, is that the production methods available to form the air electrode are limited. For example, previous attempts to produce air electrodes using a screw extrusion process have been unsuccessful due to fact that the resulting extruded films were very brittle and included cracks, pinholes, and other undesirable defects, and also that PTFE has a relatively high melting point that does not lend itself well to certain other types of formation processes. This is true both for dry pastes and for solvent-based PTFE-containing pastes.

It would be advantageous to provide an improved battery and structures/features therefore that address one or more of the foregoing issues. It would also be advantageous to provide an improved material for use in producing air electrodes (or components thereof) that would provide enhanced mechanical strength to the resulting air electrode, while maintaining other desirable characteristics (e.g., conductivity, gas permeability, etc.) of the air electrode. It would also be advantageous to provide an improved material for air electrodes that may allow the air electrode to be produced using different processes that may have been used in the past. It would also be advantageous to provide a metal-air battery that may be used in a variety of applications, including, but not limited to, large scale and small scale applications. Other advantageous features will be apparent to those reviewing the present disclosure.

### SUMMARY

An exemplary embodiment relates to a method of producing an air electrode for a metal-air battery that includes forming at least a portion of the air electrode using a process selected from the group consisting of an injection molding process and a screw extrusion process.

Another exemplary embodiment relates to a method of producing an air electrode for a metal-air battery that includes forming a gas diffusion layer for the air electrode using a screw extrusion process or an injection molding process, the gas diffusion layer comprising at least one material selected from the group consisting of polyethylene and polypropylene. The method also includes adding an active layer to the gas diffusion layer.

Another exemplary embodiment relates to an air electrode for a metal-air battery that includes a gas diffusion layer comprising at least one material selected from the group consisting of polyethylene and polypropylene and an active layer that does not include polyethylene or polypropylene.

### BRIEF DESCRIPTION OF THE DRAWINGS

FIG. 1 is a perspective view of a metal-air battery in the form of a coin cell according to an exemplary embodiment.

FIG. 2 is a cross-sectional view of the metal-air battery shown in FIG. 1.

FIG. 3 is a perspective view of a metal-air battery having a prismatic configuration according to an exemplary embodiment.

FIG. 4 is a cross-sectional view of the metal-air battery shown in FIG. 3.

FIG. 5 is detail cross-sectional view of the cross-section shown in FIG. 4.

FIG. 6 is a partially exploded perspective view of a flow battery according to an exemplary embodiment.

FIG. 7 is a cross-sectional view of a portion of a battery having a housing formed at least in part of an air electrode according to an exemplary embodiment.

FIG. 8 is a schematic view of an injection molding machine that may be used to produce air electrodes or components thereof according to an exemplary embodiment.

FIG. 9 is a schematic view of a screw extruder that may be used to produce air electrodes or components thereof according to an exemplary embodiment.

FIG. 10 is a schematic view of a portion of a screw extruder that may be used to produce air electrodes or components thereof according to another exemplary embodiment.

FIG. 11 is a schematic view of a slot die extruder that may be used to produce air electrodes or components thereof according to an exemplary embodiment.

FIG. 12 is a schematic view of a multi-layer air electrode according to an exemplary embodiment.

FIG. 13 is a sectional view of a plurality of sublayers of the gas diffusion layer of the multi-layer air electrode shown in FIG. 12.

FIG. 14 is a sectional view of a plurality of sublayers of the active layer of the multi-layer air electrode shown in FIG. 12.

### DETAILED DESCRIPTION

According to an exemplary embodiment, a metal-air battery or cell is provided that includes an air electrode that incorporates binder materials that provide improved mechanical strength for the air electrode. For example, materials such as polypropylene (PP) and/or polyethylene (PE) may be used in the air electrode in addition to or in place of a material such as polytetrafluoroethylene (PTFE). The PP/PE binder materials may be used in the active layer and/or the gas diffusion layer of the air electrode. These binder materials may be used in every sublayer that makes up the active layer and/or the gas diffusion layer, or may be provided only in one or more selected sublayers (e.g., an active layer having five layers may have the PP and/or PE materials provided in all of the sublayers or only in a subset of the sublayers).

The use of PP and/or PE within the air electrode advantageously provides increased mechanical strength for the material of the air electrode and also has a lower melting point than PTFE, which may allow the air electrode to be produced using methods that have heretofore not been used to form air electrodes. According to an exemplary embodiment, the air electrode (or components thereof, such as the active layer, oxygen evolution layer, and/or gas diffusion layer, or sublayers of such layers) may be produced using an injection molding process or an extrusion process such as a screw extrusion process. According to other exemplary embodiments, the air electrode may be produced using a combination of different methods. For example, the gas diffusion layer may be produced using a screw extrusion process and the active layer may be produced using an injection molding process, after which the two layers may be joined together by a lamination process or other suitable process. According to other exemplary embodiments, either the active layer or the gas diffusion layer may be produced using an injection molding process or a screw extrusion process, and the other layer may be formed using another method (e.g., by printing, spraying, spin coating, dip coating, etc. the other layer onto the active layer or gas diffusion layer).

The ability to use injection molding and/or screw extrusion to form components of the air electrode may advantageously allow the air electrode to be formed into shapes and configurations that were previously not thought to be possible. For example, the air electrode may be produced with a relatively complex shape in an injection molding process that would not be possible with a more conventional slot die extrusion or other process previously used. This may allow air electrodes to be produced in a way that allows for more flexible design so that the air electrodes can be tailored to fit in a predetermined space within a battery or device.

According to one exemplary embodiment, these processes may be used to form an air electrode that forms all or a portion of the external housing of a metal-air battery. This may have particular utility with electronic devices such as cellular phones, personal digital assistants (PDAs), and the like. In this manner, the outer surface of the battery may act both as the housing and as an air electrode, and the oxygen from the surrounding environment may be evenly distributed over the entire air electrode since there is no housing between the air electrode and the environment. According to an exemplary embodiment, the external surface of the metal-air battery that is defined by the air electrode may be positioned such that the external surface also forms a portion of an external surface of a device in which the battery is used (e.g., the air electrode that defines a portion of the housing may also serve as a portion of the outer surface of the housing for a cellular phone, in which case the air electrode would be directly in contact with the environment outside the phone).

The metal-air battery may have any desired configuration, including, but not limited to coin or button cells, prismatic cells, cylindrical cells (e.g., AA, AAA, C, or D cells in addition to other cylindrical configurations), flow cells, fuels cells, etc. Further, the metal-air battery may be a primary (disposable, single-use) or a secondary (rechargeable) battery. Rechargeable metal-air batteries are available due to the development of bifunctional air electrodes and the utilization of rechargeable anode materials.

There are difficulties associated with sealing metal-air batteries because the air electrode has to be open to one side in order to allow oxygen into the battery. Using conventional sealing methods (e.g., gaskets, gluing, etc.) requires that a high degree of control is exercisable over the thickness tolerances. Any variation in production can result in large scrap rates. In addition, metal-air batteries often need to be stored for a long time before shipment in order to assure that the quality of the seal is sufficient. Further, glue sealing processes are complex and the glue selections may be limited by the high alkalinity of the electrolyte.

The inventors have discovered that use of materials such as PP and PE within the air electrode may provide one to more easily weld (e.g., ultrasonic weld), hot stamp, or glue the air electrodes to the housing or case of the battery, due in part to the lower melting temperature of the PP/PE materials. In some configurations, it may be desirable to form an air electrode as a sheet and then roll the sheet to form a cylindrical electrode. In such cases, the lower melting point of the PP/PE materials may allow the joining of one edge of the electrode to another edge of the electrode at a lower temperature, which may facilitate the welding, gluing, or other coupling of the air electrode to itself

Another advantage of incorporating PE and/or PP or a similar material as a binder within the air electrode relates to the way in which such materials may be processed. PTFE materials that are conventionally used with air electrodes generally come suspended in a resin with a surfactant on the surface of the materials. As part of the process of forming the air electrode, the PTFE material is milled along with the other materials in the air electrode so that it attached to the carbon materials to form a 3-D network structure, after which the material is subjected to an elevated temperature (e.g., 300° C. or greater) to burn off the surfactant to convert the material from hydrophilic to hydrophobic. One advantage of the use of PP/PE, etc. is that such materials are already hydrophobic, and there is no need to burn off surfactants during the production of the air electrode.

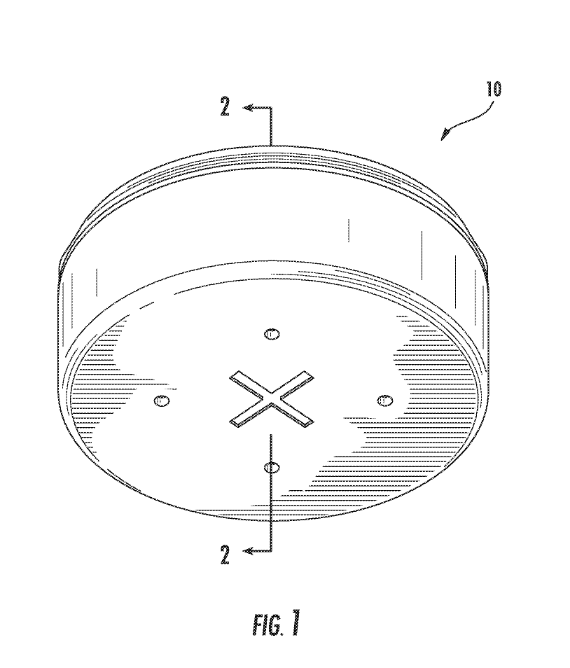

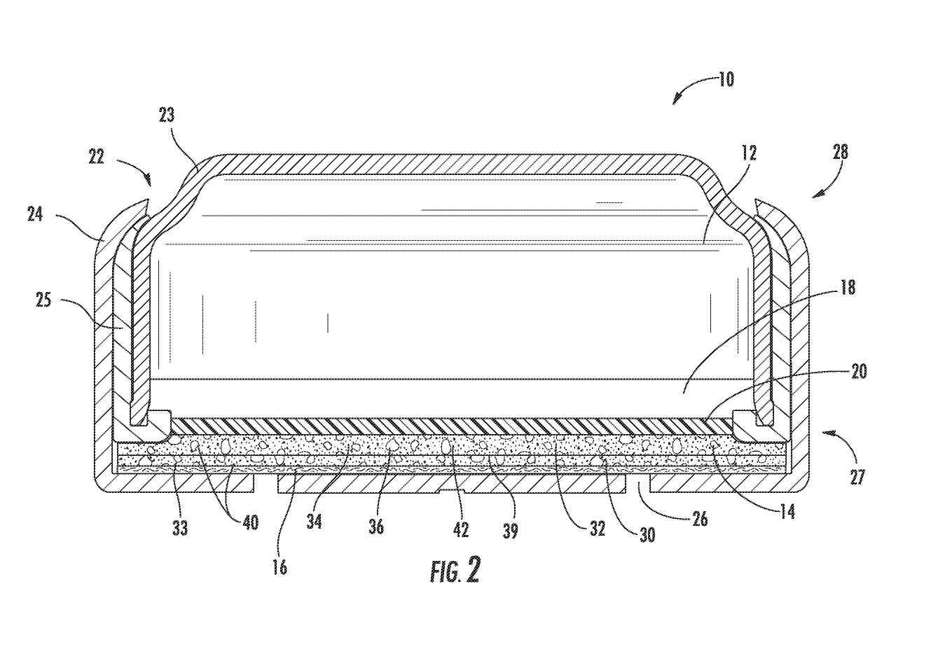

Referring to FIGS. 1-2, a metal-air battery 10 shown as a coin or button cell is illustrated according to an exemplary embodiment.

Referring to FIG. 2, the battery 10 includes a metal electrode 12, an air electrode 14 including a gas diffusion layer 30 and an active layer 32 (the active layer possibly also including an oxygen evolution layer), an electrolyte 18, a separator 20, an oxygen distribution layer 16 (e.g., a non-woven fibrous material intended to distribute oxygen entering the system evenly throughout the air electrode 14), and an enclosing structure shown as a housing 22 according to an exemplary embodiment.

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “ABₓ” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown including a base 23 and a lid 24 according to an exemplary embodiment. A seal 25 (e.g., a molded nylon sealing gasket, etc.) is formed/disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 at a first portion 27 of the housing 22 generally opposite a second portion 28. The metal electrode 12 is shown disposed within housing 22 at or proximate to the second portion 28. The air electrode 14 is shown disposed at or proximate to the first portion 27, and spaced a distance from the metal electrode 12. The holes 26 (e.g., apertures, openings, slots, recesses, etc.) provide for interaction between the air electrode 14 and the oxygen in the surrounding atmosphere (e.g., air), with the oxygen distribution layer 16 allowing for relatively even distribution of the oxygen to the air electrode 14. The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The separator 20 is a thin, porous, film or membrane formed of a polymeric material and disposed substantially between the metal electrode 12 and the air electrode 14 according to an exemplary embodiment. The separator 20 is configured to prevent short circuiting of the battery 10. In some exemplary embodiments, the separator 20 includes or is made of polypropylene or polyethylene that has been treated to develop hydrophilic pores that are configured to fill with the electrolyte 18. In other exemplary embodiments, the separator may be made of any material configured to prevent short circuiting of the battery 10 and/or that includes hydrophilic pores.

The electrolyte 18 is shown disposed substantially between the metal electrode 12 and the air electrode 14 according to an exemplary embodiment. The electrolyte 18 (e.g., potassium hydroxide (“KOH”) or other hydroxyl ion-conducting media) is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge. The electrolyte 18 is disposed within some of the pores of the metal electrode 12 and some of the pores of the air electrode 14. According to other exemplary embodiments, the distribution and location of the electrolyte may vary (e.g., the electrolyte may be disposed in the pores of the metal electrode and to a lesser degree within the pores of the air electrode, etc.).

According to an exemplary embodiment, the electrolyte 18 is an alkaline electrolyte used to maintain high ionic conductivity between the metal electrode and the air electrode. According to other exemplary embodiments, the electrolyte may be any electrolyte that has high ionic conductivity and/or high reaction rates for the oxygen reduction/evolution and the metal oxidation/reduction (e.g., NaOH, LiOH, etc.). According to still other embodiments, the electrolyte may include salt water or others salt-based solutions that give sufficient conductivity for the targeted applications (e.g., for marine/military applications, etc.).

According to an exemplary embodiment, the metal electrode and the electrolyte are combined (e.g., mixed, stirred, etc.). The combination of the metal electrode and the electrolyte may form a paste, powder, pellets, slurry, etc.

The air electrode 14 includes one or more layers with different properties and a current collector 39 (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the housing 22. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. Further, other layers may be included in/on or coupled to the air electrode, such as a gas selective membrane.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

Referring further to FIG. 2, the current collector 39 is disposed between the gas diffusion layer 30 and the active layer 32 of the air electrode 14 according to an exemplary embodiment. According to another exemplary embodiment, the current collector may be disposed on the active layer (e.g., when a non-conductive layer or no gas diffusion layer is included in the air electrode). The current collector 39 may be formed of any suitable electrically-conductive material.

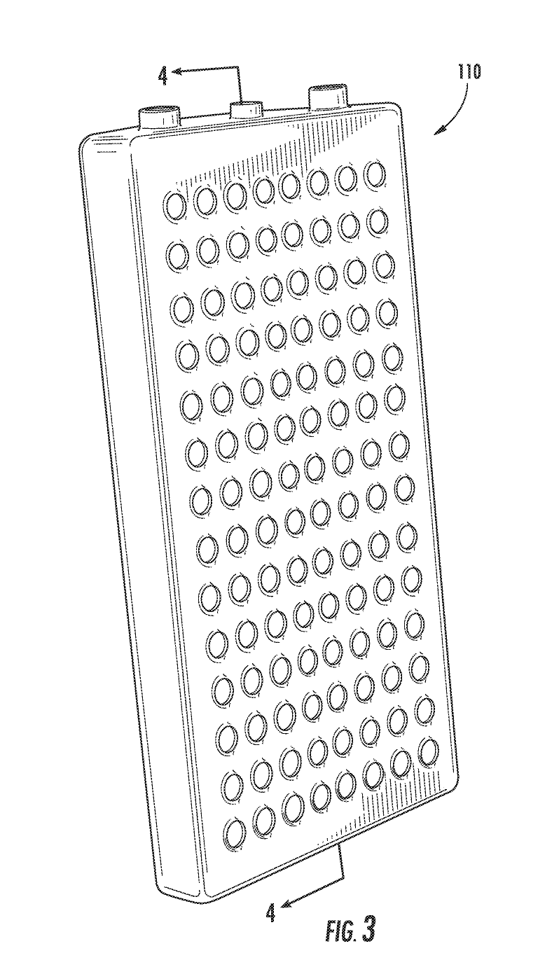

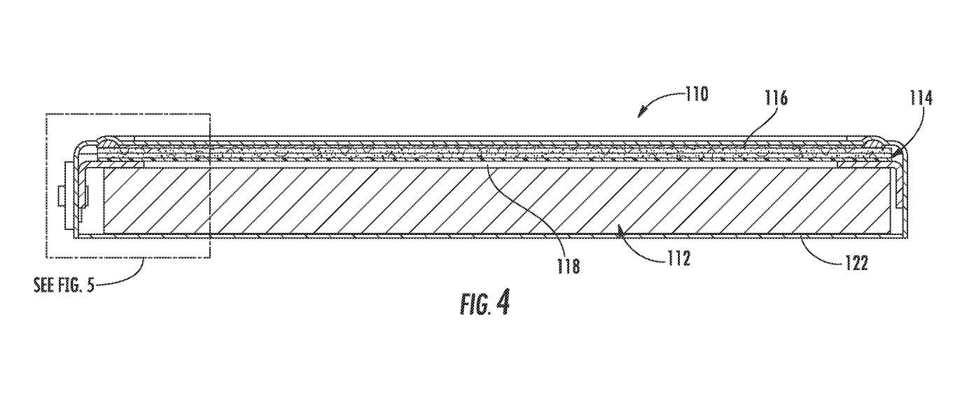

Although FIGS. 1-2 have been described in the context of a button or coin cell type battery, it should be noted that other configurations are also possible. For example, referring to FIGS. 3-5, a prismatic metal-air (e.g., zinc-air) battery 110 is shown according to an exemplary embodiment. FIG. 4 shows a cross-sectional view of the battery 110, and FIG. 5 shows a detail view of one end of the battery 110 taken across line 5-5 in FIG. 4. The battery 110 includes a housing 122, a metal electrode 112 running along the length of the cell, an air electrode 114 (which includes a gas diffusion layer 130 and an active layer 132, along with a current collector provided therein similar to the current collector 39 described above (not shown)), an electrolyte 118 provided in the space between the metal electrode 112 and the air electrode 114, and a separator 120 between the electrolyte 118 and the air electrode 114. An oxygen distribution layer 116 (similar to that described with respect to the oxygen distribution layer 16 for the coin cell embodiment described above with respect to FIG. 2) may optionally be provided between the air electrode 114 and the housing 122. The upper portion of the housing 122 contains holes 126 (e.g., slots, apertures, etc.) for air to enter the battery 110.

The air electrode 114 may be secured (e.g., by gluing, welding (e.g., ultrasonic welding, hot stamping, etc.), or the like) to the lid of the housing to prevent leakage. The gas diffusion layer side of the air electrode faces the holes 126 in the battery housing 122, and the oxygen distribution layer 116 is positioned substantially between the gas diffusion layer and the holes 126 in the housing 122. The battery 110 is filled with a metal (e.g., zinc) paste. Current collectors for the air electrode and the metal electrode may be attached using contact pins by resistance welding, laser welding, or other methods known in the art and shielded (e.g., with glue) to prevent gassing in the cell. The housing is then closed off (other than the air holes) (e.g., by ultrasonic welding).

The battery 110 provides for a commercially viable prismatic battery that may be used in numerous applications wherein prismatic batteries are or may be used because battery 110 provides, in addition to a high current density, a lifetime in that is sufficient and/or desirable for these applications (e.g., cell phones, cameras, MP3 players, portable electronic devices, etc.).

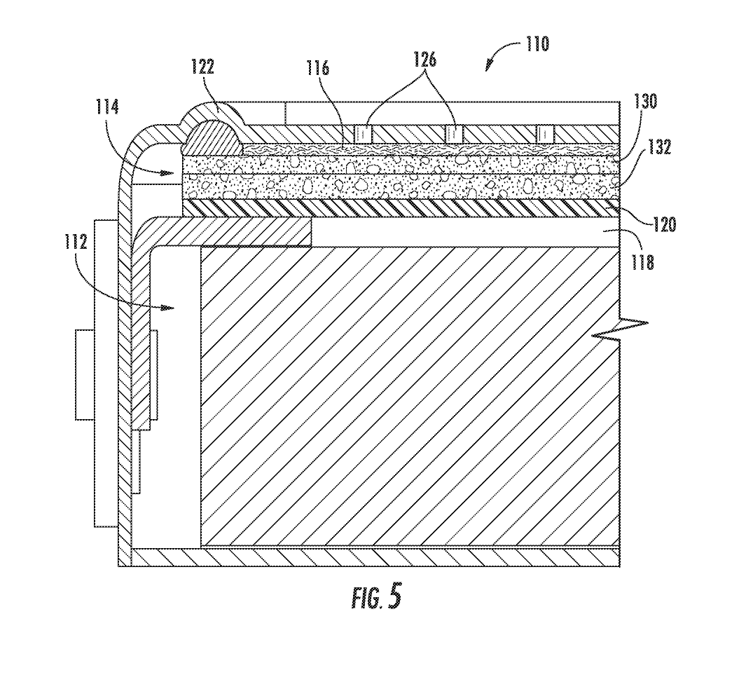

FIG. 6 illustrates an exemplary embodiment of a flow battery 210 similar to those disclosed in International Application PCT/US10/040445 and corresponding U.S. patent application Ser. No. 12/826,383, each filed Jun. 29, 2010, the entire disclosures of which are incorporated herein by reference.

Referring to FIG. 6, a metal-air flow battery shown as a zinc-air flow battery 210 is shown according to an exemplary embodiment. The term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

The zinc-air flow battery 210 is shown as a closed loop system including a zinc electrode 212, an electrolyte 218, one or more storage devices shown as tank or chamber 244, and a reactor 246 having one or more reaction tubes 248, each of the reaction tubes 248 including an air electrode 214 (which, like the air electrodes described above, includes a gas diffusion layer and an active layer).

The zinc electrode 212 is combined with the electrolyte 218 to form a zinc paste 250, which serves as a reactant for the zinc-air flow battery 210 according to an exemplary embodiment. The reactant (e.g., active material, etc.) is configured to be transported (e.g., fed, pumped, pushed, forced, etc.) into and out of the reactor 246. When the zinc-air flow battery 210 is discharging, the zinc paste 250 is transported into the reactor 246 and through the reaction tubes 248 and a zinc oxide paste 252 is transported out of the reactor 246 after the zinc paste 250 reacts with the hydroxyl ions produced when the air electrode 214 reacts with oxygen from the air. When the zinc-air flow battery 210 is charging, the zinc oxide paste 252 is transported into the reactor 246 and through the reaction tubes 248 and the zinc paste 250 is transported out of the reactor 246 after the hydroxyl ions are converted back to oxygen. The pastes 250, 252 are stored in the tank 244 before and after being transported through the reactor 246, the zinc paste 250 being stored in a first cavity 254 of the tank 244 and the zinc oxide paste 252 being stored in a second cavity 256 of the tank 244. According to another exemplary embodiment, the tank 244 includes only a single cavity, and the zinc oxide paste is stored in the single cavity.

As discussed above, the reaction tubes 246 each include an air electrode 214 disposed between at least two protective layers. FIG. 6 illustrates one of the reaction tubes 248 of the zinc-air flow battery 210 in more detail, exploded from the zinc-air flow battery 210 according to an exemplary embodiment. The reaction tube 248 is shown having a layered configuration that includes an inner tube or base 258, a separator 270, the air electrode 214 (including a gas diffusion layer 230 and an active layer 232), and an outer tube or protective casing 262 according to an exemplary embodiment. The base 258 is shown as the innermost layer of the reaction tube 246, the protective casing 262 is shown as the outmost layer of the reaction tube 246, and the other layers are shown disposed substantially between and concentric with the base 258 and the protective casing 262.

According to the exemplary embodiment shown, the composition of air electrodes 214 enables production of tubular air electrodes according to an exemplary embodiment. The air electrode 214 includes a plurality of binders 264. The binders 264 provide for increased mechanical strength of the air electrode 214, while providing for maintenance of relatively high diffusion rates of oxygen (e.g., comparable to more traditional air electrodes). The binders 264 may provide sufficient mechanical strength to enable the air electrode 214 to be formed in a number of manners, including, but not limited to, one or a combination of injection molding, extrusion (e.g., screw extrusion, slot die extrusion, etc.), stamping, stamping, pressing, utilizing hot plates, calendaring, etc. This improved mechanical strength may also enable air electrode 214 to be formed into any of a variety of shapes (e.g., tubular, etc.).

The tubular configuration of the reaction tubes 246, and, correspondingly, the air electrodes 214, makes the air electrodes 214 relatively easy to assemble without leakage. The tubular configuration in conjunction with the conductive gas diffusion layer permits for the current collectors for the air electrodes 214 to be on the outside of the reaction tubes 246, substantially preventing any leakage from the air electrode current collector. Further, the tubular configuration permits for the current collectors for zinc electrodes 212 to be integrated substantially within reaction tubes 246, eliminating contact pin leakage.

In addition, the tubular configuration of air electrodes a 214 provides improved resistance to pressure, erosion (e.g., during transport of zinc paste 250 and zinc oxide paste 252, etc.), and flooding. For example, the tubular configuration of the air electrode permits zinc paste to flow through a passage defined thereby with less friction than if the air electrode were configured as a flat plate, causing relatively less erosion therewithin. Also, the cylindrical reaction tubes 246 having a layered configuration permits for incorporation of elements/layers providing mechanical stability and helping to provide improved pressure resistance.

During discharge of the zinc-air flow battery 210, the zinc paste 250 is fed from the tank 244 through a zinc inlet/outlet and distributed amongst the reaction tubes 246 by a feed system 272. According to the exemplary embodiment shown, the feed system 272 includes a plurality of archimedean screws 274. The screws 274 rotate in a first direction, transporting the zinc paste 250 from proximate the first end portion 276 toward the second end portion 278 of each reaction tube 246. An air flow 280 is directed by an air flow system 282, shown including fans 284, through a plurality of air flow channels 286 defined between the reaction tubes 246. The air flow 280 is at least partially received in the reaction tubes 246 through a plurality of openings 288 in the protective casing 262 and toward the passage 266, as shown by a plurality of air flow paths 290. Oxygen from the air flow 280 is converted to hydroxyl ions in the air electrode 214; this reaction generally involves a reduction of oxygen and consumption of electrons to produce the hydroxyl ions. The hydroxyl ions then migrate toward the zinc electrode 212 in the zinc paste 250 within the passages 266 of the reaction tubes 246. The hydroxyl ions cause the zinc to oxidize, liberating electrons and providing power.

As a result of its interaction with the hydroxyl ions, the zinc paste 250 is converted to the zinc oxide paste 252 within the reaction tubes 246 and releases electrons. As the screws 274 continue to rotate in the first direction, the zinc oxide paste 252 continues to be transported toward the second end portion 278. The zinc oxide paste 252 is eventually transported from reaction tubes 246 through a zinc oxide inlet/outlet and deposited in the second cavity 256 of the tank 244 (or, where only one cavity is provided, into the cavity of the tank).

As discussed above, the zinc-air flow battery 210 is rechargeable. During charging, the zinc oxide paste 252 is converted or regenerated back to zinc paste 250. The zinc oxide paste 252 is fed from the tank 244 and distributed amongst the reaction tubes 246 by the feed system 272. The screws 274 rotate in the second direction (i.e., opposite to the direction they rotate during discharging), transporting the zinc oxide paste 252 from proximate the second end portion 278 toward the first end portion 276 of each reaction tube 246. The zinc oxide paste 252 is reduced to form the zinc paste 250 as electrons are consumed and stored. Hydroxyl ions are converted to oxygen in the air electrodes 214, adding oxygen to the air flow 280. This oxygen flows from the reaction tubes 246 through the openings 288 in the protective casing 262 outward from proximate the passage 266, as shown by the air flow paths 290.

The composition, structure, and manufacture of an air electrode for use with the batteries illustrated in FIGS. 1-6 will now be discussed. For ease of reference, the following description will be presented with reference to the air electrode 14 shown and described in FIG. 2, although it should be understood by those reviewing this disclosure that the compositions, structures, and processing methods described below may be used with any of the air electrodes described above (e.g., for button or coin cell batteries, prismatic batteries, flow batteries) and with any air electrodes for metal-air batteries of other configurations (e.g., cylindrical batteries such as AA, AAA, C, and D cells or other types of cylindrical batteries, etc.).

For purposes of this discussion, an air electrode may considered to include one or more primary layers (e.g., a gas diffusion layer, an active layer, an oxygen evolution layer, etc.). Each primary layer may include one or more sublayers. It should be noted that the term “layer” as used in the discussion below may be used to refer to a primary layer or to a sublayer of a primary layer.

According to an exemplary embodiment, the air electrode 14 includes a catalyst or a combination of catalysts 42, a binding agent or combination of binding agents 40 (which may also be referred to as a binder), and/or other additives (e.g., ceramic materials, high surface area metals or alloys stable in alkaline media, etc.).

According to an exemplary embodiment, the catalysts 42 are included only in the active layer 32 and the binding agents 40 are included in both the active layer 32 and the gas diffusion layer 30. A different combination of binding agents may be provided in the various layers of the air electrode. For example, according to an exemplary embodiment, the combination of binding agents (either the types of binding agents or their quantities) in the gas diffusion layer may differ from that in the active layer and/or the oxygen evolution layer. According to another exemplary embodiment, the combinations and amounts of binding agents may differ between various sublayers of the primary layers of the air electrode. For example, where an active layer includes five separate sublayers, all or only a portion of the sublayers may include one or more binding agents, and the binder composition of the various sublayers may vary according to various design considerations (e.g., a first sublayer could include only polypropylene (PP) and/or polyethylene (PE) binding agents, while a second sublayer could include PP and/or PE along with another binding agent such as polytetrafluoroethylene (PTFE)). Of course, the catalyst composition of the sublayers of the active layer and/or oxygen evolution layer may also vary in a similar manner.

The catalysts 42 are configured to improve the reaction rate of the oxygen reactions within the battery, including the oxygen reduction and evolution reactions. According to some exemplary embodiments, catalytically active metals or oxygen-containing metal salts (e.g., Pt, Pd, Ag, Co, Fe, MnO₂, KMnO₄, MnSO₄, SnO₂, Fe₂O₃, CoO, Co₃O₄, etc.) may be used as catalysts. According to other exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, a combination of more than one of the foregoing materials may be used.

The binding agents 40 are intended to bind the components of the air electrode together while still allowing the air electrode to have relatively high oxygen diffusion rates. The binding agents 40 may also cause pores in the air electrode 14 to become hydrophobic to limit the amount of liquid transport through the air electrode.

The binding agents 40 may include, for example, polymeric materials such as polytetrafluoroethylene (PTFE), polyethylene (PE), polypropylene (PP), polyisobutylene (PIB), thermoplastics such as polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene monomer rubber (EPDM), or combinations thereof

According to an exemplary embodiment, binding agents such as PP and/or PE may be used as the only binders in a particular layer (replacing, for example, PTFE). According to other exemplary embodiments, binding agents such as PP and/or PE may be used in combination with PTFE in a particular layer to allow the benefits of PTFE (which provides, for example, excellent oxygen transport) to be balanced with the benefits of PP and/or PE (which, as described below, act to increase the mechanical strength of the air electrode).

In some exemplary embodiments, the types of binders in each of the primary layers of the air electrode is the same (e.g., the gas diffusion layer and the active layer both use PP in combination with PTFE, and the percentages of each in the layer may be the same or different). In other exemplary embodiments, the types of binders in the different primary layers of the air electrode may differ (e.g., the gas diffusion layer may use PE and/or PP with or without PTFE, while the active layer includes only PTFE as a binder). For example, it may be desirable to provide a higher or different binder content in the gas diffusion layer to form a hydrophobic barrier layer to prevent liquid penetration, while it may be desirable to use a lower binder content in the active layer to allow for a partially flooded electrode with a well-defined three-phase boundary. In another example, it may be desirable to produce either the gas diffusion layer or the active layer using an injection molding or screw extrusion process, in which case that layer would benefit from the added strength provided by PP and/or PE, while the other layer may be produced using other methods such as printing, spray coating, etc., which may not require the additional strength provided by PP and/or PE, and so only PTFE may be used in such additional layer.

In a case where the primary layers include multiple sublayers (e.g., the active layer includes two or more sublayers), the binder composition of the various sublayers may be varied to provide desired characteristics for each of the sublayers. According to an exemplary embodiment, one or more of the sublayers includes PE and/or PP in combination with PTFE and another of the sublayers includes PTFE but does not include PE or PP. By way of example and not limitation, in a case where an active layer includes five sublayers, the first sublayer may include 10 percent PTFE and 20 percent PE, the second sublayer may include 30 percent PTFE and 20 percent PE, the third layer may include 30 percent PP (with no PTFE), the fourth layer may include 30 percent PTFE (with no PE), and the fifth layer may include 10 percent PTFE, 20 percent PE, and 20 percent PP (where the foregoing percentages are weight percentages).

According to other exemplary embodiments, the sublayers may be provided such that each of the sublayers have a different ratio of PE (and/or PP or another binder) to PTFE. For example, an air electrode may have six separate sublayers, with the ratios of PE to PTFE for the successive layers being 0 (i.e., all PTFE), 0.2, 0.4, 0.6, 0.8, and 1.0 (i.e., all PE). The overall binder content for each of the sublayers (i.e., the percentage of binders as compared to other materials within the layers) may be the same for each layer or may differ. Of course, the ratios and overall binder content within the layers may differ according to other exemplary embodiments, as may the number of sublayers. For example, the successive sublayers could have ratios of 0.2, 0.4, 0.2, 0.6, 0.4, 0.8 or any other desired configuration.

As will be appreciated by those reviewing this disclosure, there are a wide variety of possible compositions for each of the sublayers (e.g., the binder materials, the ratios of binder materials within each layer, the total percentages of such binders within each layer, etc.) and for the combinations of sublayers that may be used in forming the active layer, the gas diffusion layer, and/or the oxygen evolution layer.

Certain binding agents (e.g., PE, PP) provide improved mechanical strength that allow components of the air electrode to be formed in a number of manners, including, but not limited to, injection molding, screw extrusion, stamping, pressing, utilizing hot plates, calendering, etc. that were not previously possible for air electrodes that utilized only PTFE as a binder (since the PTFE by itself did not allow for certain formation methods such as screw extrusion or injection molding to be used because of the relatively low strength of the air electrode material and the relatively high melting point of PTFE). This improved mechanical strength also enables air electrode 14 to be formed into any of a variety of shapes (e.g., a tubular shape, a shape to accommodate or correspond to the shape of a housing, etc.) that were not previously believed to be possible using conventional air electrode formation methods. The ability to form the air electrode into any of a variety of shapes enables use of metal-air batteries in a wide variety of applications such as Bluetooth headsets, applications for which tubular batteries are used or required (e.g., size AA batteries, size AAA batteries, size C or D batteries), etc. More generally, the use of additional binding agents such as PE and/or PP in the air electrode 14 allows for improved/new electrode formation methods, shapes, and applications for metal-air batteries as discussed in more detail below. The ability to form air electrodes having different shapes may also allow one to produce batteries having smaller housings or may allow for the inclusion of more metal-anode material within the battery.

In addition to providing increased mechanical strength for the air electrodes, polymeric materials such as PP and PE may also provide additional benefits for the air electrode, such as improving the resistance to chemical or mechanical degradation of the air electrode during operation.

As described herein, the inclusion of PE and/or PP within a layer of the air electrode 14 is intended to provide enhanced mechanical strength to the layer as compared to a layer including only PTFE, which may advantageously allow the layer to be formed using methods that heretofore have not been utilized to form such layers. A series of experiments were conducted to evaluate layers incorporating PE at various percentages, which will now be described.

A number of air electrode layers were prepared using varying percentages of PTFE (PTFE resin 6C-N, commercially available from DuPont) and PE (HA2454, also commercially available from DuPont). Other components of the layer included a high surface area carbon (carbon black XC72, commercially available from Cabot), a solvent such as Terlitol D60, commercially available from Shell or iso-propanol, commercially available from Sigma Aldrich. The samples were processed according to various different methods. For example, for the baseline samples of a layer with only PTFE binders, the binder and other materials were milled and calendared to a desired thickness and pressed twice at a pressure of 80 bar at a temperature of 70° C., after which they were dried at 80° C. and heat treated for 2.5 hours at 320° C. Similar processes were used for the samples that included various percentages of PE incorporated therein, although it should be noted that such layers were heat treated for a period of three hours at a temperature of approximately 140° C.

The samples were then subjected to a number of tests to determine the surface resistance (Rs), tensile strength, and elongation. The porosity (air penetration) of the layers was tested using the High Pressure Densometer (Model 4150N GENUINE GURLEY™) which measures the time required for a specific volume of air (10 cc), at a constant pressure of 12.33 inches (31.31 cm) W.C., to flow through a standard area of the material being tested. The air pressure is supplied by a weighted inner cylinder floating freely within an outer cylinder which is partially filled with oil to act as a seal. The sample material is held between clamping plates having a circular orifice area of 1.0 square inch (6.45 cm²). The air penetration measurements provide insight into the ability for air to access the catalyst and, therefore, it is an indicator for the reaction rate possible to active without running into a limited current situation.

In terms of in-plane tensile strength, as compared to baseline samples having 50 weight percent PTFE and no PE, the samples that included a mixture of 10 percent PTFE on combination with 40 or 60 percent PE exhibited significantly higher tensile strengths and lower elongations at the point of tensile strength and breakage, indicating that the samples incorporating 40 or 60 percent PE would be able to withstand significantly higher loads than the base PTFE samples. The results of such testing are shown in Table 1. Although there were variations within the results for the samples having similar binder contents, such variation may be due to a number of factors, including the differing manners in which each of such samples were processed.

TABLE 1

| | | | | Load at | Elongation | |
|---|---|---|---|---|---|---|
| | | | | tensile | (mm) at | |
| | % | % | | strength | tensile | |
| Sample | PTFE | PE | Solvent | (N) | strength | break |
| Base 1 | 50 | — | D60 | 5.6 | 3.6 | 5 |
| Base 2 | 50 | — | D60 | 9 | 5 | 8.5 |
| 1 | 10 | 40 | D60 | 21.4 | 0.8 | 0.8 |
| 2 | 10 | 40 | D60 | 25.5 | 0.74 | 0.74 |
| 3 | 10 | 40 | D60 | 23.4 | 0.69 | 0.69 |
| 4 | 10 | 40 | D60 | 47 | 1.1 | 1.1 |
| 5 | 10 | 40 | i-PrOH | 20.3 | 1.1 | 1.1 |
| 6 | 10 | 40 | i-PrOH | 34.2 | 1.1 | 1.1 |
| 7 | 10 | 40 | i-PrOH | 42.6 | 0.9 | 0.9 |
| 8 | 10 | 60 | D60 | 48.8 | 1.83 | 1.83 |

Peel tests were performed in which tape was applied on a 20 mm×25 mm portion of the layers and peeling the tape off by hand, after which the tape was visually inspected to determine the amount of material left behind on the tape. While the baseline PTFE-only samples left behind a significant amount of carbon material (such that the tape appeared almost completely black), only a very small amount of carbon was left behind on the samples using only 10 percent PTFE in combination with 40 or 60 percent PE. This suggests that the carbon is well incorporated in the layers including PE and are bound within the layer such that the carbon would have less tendency to leach out of the air electrode during use. Better adhesion between the carbon particles also indicates better performance in terms of corrosion, erosion, flooding, and leaching of catalyst into the electrolyte.

Preliminary experiments suggest that the conductivity (i.e., the inverse of surface resistance of the layers) and air penetration (e.g., as measured by Gurley units) may be controlled by varying the processing conditions during formation of the layers. This in turn may allow one to tailor the performance of an air electrode so as to provide a desired rate capability and conductivity for an intended application. Under certain conditions, it was found that similar conductivity and air penetration values could be achieved for samples both with PE (e.g., 40 percent PE and 10 percent PTFE) and without PE (e.g., 50 percent PTFE).

According to an exemplary embodiment, the air electrode 14 is formed in a multi-step process. First, the desired component elements of each layer are mixed together. The pore forming materials, the catalysts, the binding materials and/or other additives are mixed under the influence of mechanical, thermal, or mechanical and thermal energy. It is desirable that the materials be well distributed. If the mixture contains a hydrophobic binding agent, then this binding agent forms a three dimensional network connecting the powders into an agglomerate.

Second, each mixture is formed into a layer (which may be a primary layer or a sublayer of a primary layer), as will be described in greater detail below. For example, a gas diffusion layer may be produced using an injection molding or screw extrusion process (or another type of process, such as forming the material into a brick and calendering it to a desired thickness, using a slot die extrusion process, forming the layer in a printing, spraying, spin coating, dip coating, or other suitable process, etc.), and the active layer may be produced using a separate injection molding or screw extrusion process (or another type of process, such as forming the material into a brick and calendering it to a desired thickness, using a slot die extrusion process, forming the layer in a printing, screening, spraying, or other suitable process, etc.). The processes used to form the different primary layers of the air electrode (and/or the different sublayers of any of the primary layers if such sublayers are present) may be the same or may differ. For example, a screw extrusion process may be used to form the gas diffusion layer and an injection molding or slot die process may be used to form the active layer. Other combinations are possible according to other exemplary embodiments.

Third, two or more of the layers (e.g., a gas diffusion layer and an active layer) are coupled together. According to an exemplary embodiment, the layers may be joined using heat and/or pressure (e.g., by calendering and/or pressing). According to another exemplary embodiment, a first layer may be formed and a second layer may be formed directly onto the first layer (e.g., using a printing or spraying process, etc.), in which case the second and third steps are effectively combined into a single step.

Fourth, the current collector is coupled (e.g., pressed or calendered) into the combined layers (e.g., into the active layer, into the gas diffusion layer, between the active layer and the gas diffusion layer, etc.). According to an exemplary embodiment, the current collector is sandwiched between the active layer and the gas diffusion layer, and may be joined to both layers in conjunction with the third step described above in which the active layer and the gas diffusion layer are joined. According to another exemplary embodiment, the current collector may be coupled to the gas diffusion layer (e.g., by pressing or calendering) and the active layer may subsequently be applied over the current collector (e.g., by pressing a calendering the active layer to the current collector or by forming layers directly over the current collector using a process such as printing, spraying, spin coating, dip coating, etc.).

According to an exemplary embodiment, a dry mixing process is utilized in the first step to form the layers of air electrode 14. In a dry mixing process, all of the ingredients of a layer are mixed together in the form of dry powders. In a case where carbon itself does not form the pore structure, an additional pore forming aid such as ammonium bicarbonate may be used to create the gas diffusion layer and/or the oxygen evolution layer.

According to other exemplary embodiments, a wet mixing process may instead be utilized. In a wet mixing process, one or more solvents are added at the beginning or during the mixing process, or, alternatively, one or more ingredients may be used in the form of a dispersion or suspension. The solvent(s) are typically subsequently removed (e.g., directly after the mixing process or in a later state of the production process) (e.g., by using a heating/drying process). According to an exemplary embodiment, a wet process utilizes one or more binders that are suspended in water or another solvent and a pore forming aid or a carbon material in the gas diffusion layer is used to form pores.

According to still another exemplary embodiment, the various individual layers may be made using different methods. For example, some of the layers may be produced using a dry mixing process, while others may be produced using a wet process. According to yet still another exemplary embodiment, it is possible to combine both dry and wet processes for the different layers and the production may be performed in a continuous production line according to PCT publication WO 2005/004260, the disclosure of which is incorporated herein by reference.

An oxygen evolution layer may be included in the air electrode. According to an exemplary embodiment, the oxygen evolution layer may include 2 to 15 percent binding agent by weight and 25 to 65 percent catalyst(s) by weight. The remainder of the oxygen evolution layer may include a high surface area carbon and/or graphite material and possibly some other additives.

An exemplary embodiment of an air electrode formation method utilizing a dry mixing process will now be discussed. According to this method, the active layer is prepared using a mixture of 15 percent PTFE by weight (e.g., in powder form with a particle size below 1 mm from Lawrence Industries of Thomasville, N.C. as a binding agent), 70 percent high surface area carbon (e.g., XC 500 from Cabot) by weight as a pore forming agent, and 15 percent manganese sulfate (e.g., MnSO₄ from Prolabo of France) by weight as a catalyst. The binding agent, the pore forming agent, and the catalyst are mixed together (e.g., in a single-shaft rotary mixer at approximately 1,000 rpm) to form a substantially homogeneous mixture. The mixture is heated to a desired temperature. When the powder mixture reaches the desired temperature, the powder is milled to form an agglomerate. For example, the mixture may be heated to a desired temperature at or near 90° C. and milled at approximately 1,000 rpm for 1 hour, or the mixture may be heated to a lower initial temperature, but milled at a higher rpm (e.g., 10,000 rpm). The agglomerate is pressed into a brick (e.g., a brick of about 2 mm thickness) and then calendered into a sheet (e.g., of about 0.5 mm thickness). According to other exemplary embodiments, the temperatures, milling rates and times, and other parameters may vary depending on the particular materials used and other factors.

The gas diffusion layer is formed using a mixture of a binding agent (e.g., PTFE in conjunction with PP and/or PE) and ammonium bicarbonate size below 10 μm from Sigma-Aldrich, Inc.) as a pore forming agent. The binding agent and the pore forming agent are mixed at a desired temperature (e.g., typically below a maximum temperature of 40° C.) in a single-shaft rotary mixer (e.g., for 2 hours at 1,500 rpm) to form an agglomerate. The agglomerate is pressed into a brick (e.g., of about 2 mm thickness) and then calendered into a sheet (e.g., of about 1 mm thickness).

An exemplary embodiment of an air electrode formation method utilizing a wet mixing process will now be discussed. According to this method, the active layer is prepared using 15 percent PTFE by weight in a suspension containing 60 percent PTFE by weight dispersed in water (e.g., from Sigma-Aldrich, Inc.) as a binding agent, 65 percent high surface area carbon (e.g., XC 500 from Cabot) by weight as a pore forming agent, and 20 percent manganese sulfate (e.g., MnSO₄ from Prolabo of France) by weight as catalysts. The high surface area carbon is mixed with both catalysts in water. Separately, the PTFE suspension is mixed with water. The PTFE suspension is then added to the carbon suspension and mixed to form a slurry agglomerate. The slurry is then mixed (e.g., in an ultrasonic bath for 30 minutes) and subsequently dried (e.g., at 300° C. for 3 hours) to remove any surfactants. The dried mixture is then agglomerated and a hydrogen treated naphtha with a low boiling point (e.g., Shellsol D40 from Shell Chemicals of London) is added to form a paste. Finally, the paste is calendered into a thin layer to form the active layer.

The hydrophobic gas diffusion layer may be formed by the same method according to an exemplary embodiment. In this layer, only high surface area carbon (65 percent by weight) and a binding agent such as PTFE in combination with PE and/or PP (for a total binder content of 35 percent by weight) are used. The final layer is relatively thin (e.g., having a thickness of about 0.8 mm).

The active layer and the gas diffusion layer are then coupled (e.g., by calendering) to form the air electrode (e.g., having a total thickness of 0.8 mm). Finally, a current collector (e.g., nickel mesh) is pressed into the air electrode (e.g., at 70 bars and at a temperature of between approximately 80° C. and 320° C.) between the active layer and the gas diffusion layer. The air electrode may then be dried (e.g., at 70° C. for 8 hours) to create the hydrophobic porosity of the gas diffusion layer.

It should be noted that according to other exemplary embodiments, the percentages, thicknesses, and compositions of the various layers may differ from those described in the foregoing dry and wet process examples.

As described above, the use of PP and/or PE may provide enhanced mechanical strength which may allow alternative manufacturing processes to be used to form layers of the air electrode that have not been previously used in the manufacture of air electrodes. For example, injection molding and screw extrusion processes, while used in various industries to produce plastic parts, have not been used in the process of forming air electrodes or components thereof due to the characteristics of the materials conventionally used for such air electrodes or components thereof.

According to an exemplary embodiment, an injection molding process may be used to form the air electrode 14 or portions of the air electrode 14. Where the gas diffusion layer and the active layer are both formed using an injection molding process, they may be formed separately or in combination.

Although injection molding is a known process used to form plastic parts, such a process has not conventionally been used to form air electrodes for metal-air batteries. The surprising discovery that the incorporation of PE and/or PP (or other polymeric materials) into the material used to form the air electrodes provides improved mechanical strength without reducing conductivity or air diffusion rates and allows for the use of novel production methods for metal-air battery components such as injection molding.

According to one exemplary embodiment, binders (e.g., binding agents such as PE and/or PP, alone or in combination with PTFE or another binder) are added to a powder mixture including other materials used to form one or more of the primary layers of the air electrode (e.g., the active layer, the gas diffusion layer, etc.). According to one exemplary embodiment, PP and/or PE binders are added in the form of fine particles.

The powder mixture is heated to a temperature above the melting point of the PP and/or PE and mixed using a blender or other suitable mixing device. Once the PP and/or PE has been melted, the resultant liquid is forced into a mold using a pump, piston, or feed screw. The temperature of the PP and/or PE is then reduced to solidify the liquid to form an air electrode or portions thereof. The resultant injection molded “part” may then be removed from the cavity of the mold.

The mold includes a cavity corresponding to the desired shape of an air electrode or portions thereof (e.g., the gas diffusion layer and/or the active layer, a sublayer of a primary layer, etc.), and may be made from any suitable material, including steel, aluminum, or other materials used to form molds for use in injection molding operations. The molds may include flat portions, curved portions, textured portions, combinations thereof, etc.

The use of an injection molding process may allow the formation of parts having a wide variety of shapes, sizes, and configurations. According to an exemplary embodiment, the air electrode may be formed to substantially correspond to the shape of a battery housing or other structure (e.g., a housing for a cylindrical cell, a button cell, or a prismatic cell, etc.). This may particularly useful in forming air electrodes for applications where size constraints are critical (e.g., small batteries such as hearing aid batteries).

Another benefit of the injection molding process is that it allows an air electrode to be shaped in a manner that more efficiently utilizes the space defined by the housing (e.g., avoiding the creation of open, unutilized areas, etc.). Freeing up more space in the housing allows for the inclusion of a greater quantity or volume of desirable materials therein. For example, the capacity of a metal-air battery is generally directly related to the amount (e.g., volume) of the metal anode material that can be disposed within the housing of the metal-air battery. It follows that by increasing the amount of metal anode material in the housing of the metal-air battery, one can produce metal-air batteries having higher capacities. By utilizing materials such as PP/PE within the air electrode, the active surface area of the air electrode may be increased, which in turn allows the battery to deliver higher amounts of power for a given battery volume.

According to an exemplary embodiment of a metal-air battery configured to have increased capacity, the metal-air battery includes a housing and an air electrode. At least part of the space made available through the use of the air electrode production process is occupied by metal anode material, increasing the capacity of the metal-air battery. According to another exemplary embodiment, the more efficient usage of space allows for use of a housing that is smaller than housing used with metal-air batteries having the same capacity, but using air electrodes produced by more conventional production methods. Smaller housings may be useful in many applications wherein the device in which the battery is used is relatively small, wherein the device would be more desirable if it were smaller, etc.

According to a particular exemplary embodiment, air electrodes for use in a flow battery such as that shown in FIG. 6 may be produced in whole or in part using an injection molding process. The gas diffusion layer and the active layer may be injection molded into a tubular shape or may be formed flat and wrapped about a support structure to achieve a tubular shape (the gas diffusion layer and active layer may be formed separately or may be formed together in a single injection molding operation.

Injection molding processes may be incorporated into the air electrode manufacturing process in a variety of different manners. For example, according to one exemplary embodiment, a gas diffusion layer mixture may be melted and injected into a mold. The injected mixture may then be cooled and removed from the mold to form a gas diffusion layer. An active layer for the air electrode may then be applied to the gas diffusion layer (e.g., using spray printing, screen printing, spin coating, dip coating, or another suitable process). The active layer may then be heat sintered.

According to another exemplary embodiment, an air electrode production process includes injection molding a first layer of an air electrode. Successive layers are then formed on the first layer using a printing, spraying, spin-coating, dip-coating, or other suitable process. According to one exemplary embodiment, the first layer is the gas diffusion layer. According to some exemplary embodiments, the active layer may be formed onto an injection molded gas diffusion layer using a spin coating and/or spray printing process. According to another exemplary embodiment, the first layer is an active layer. According to some exemplary embodiments, the first layer is a sublayer of a primary layer.

According to another exemplary embodiment, a complete air electrode may be formed during a single injection molding process. The injection molding process may be configured to provide for the use of two or more different mixtures of material (e.g., using two separate injection nozzles to keep the materials separate), providing for distinction between the gas diffusion layer, the active layer, and possibly sublayers used to form one or both of these primary layers.

According to an exemplary embodiment, an air electrode may be injected molded to form and function as the housing of a metal-air battery (e.g., for hearing aids, portable electronics, etc.). FIG. 7 illustrates a cross-sectional view of a battery 310 a housing formed from a first portion 322 and a second portion 324. Within the housing are a metal electrode 312, a separator 318, and a separator 320. Such internal components may have any of the configurations as discussed with respect to the various exemplary embodiments described herein. The first portion 322 of the housing may be formed of a material such as a metal, polymer, composite, or other suitable material. The second portion 324 of the housing is provided as an air electrode 314 having a gas diffusion layer 330 and an active layer 332 (having binding agents 340 provided therein). The second portion 324 may be formed in an injection molding or other suitable process, and the active layer and/or the gas diffusion layer may include a binder composition that uses polymeric materials such as PP and/or PE in place of or in addition to PTFE or other more conventional binder materials. According to an exemplary embodiment, the second portion 324 is configured such that the air electrode is directly exposed to the atmosphere outside of the battery 310 and forms an outer surface 325 of the housing. The second portion 324 may be secured to the housing 322 by welding, gluing, or any other suitable connection method. Because the gas diffusion layer 330 of the housing is directly exposed to the surrounding atmosphere, a uniform oxygen distribution may be obtained throughout the air electrode.

According to another exemplary embodiment, the entire housing of the battery may be formed of an air electrode material such as air electrode 314, in which case a separator or other structure would be provided between the entire inner surface of the housing and the metal electrode to prevent short circuiting of the battery.

The formation of a battery having an exterior surface that is formed of an air electrode may have utility in a variety of applications, including cellular phones, computers, and other electronic devices. One advantageous feature of such a configuration is that a portion of the housing may be eliminated (along with an optional oxygen distribution layer 16 between the housing and the air electrode), which may result in a more compact battery size, which may in turn allow for space savings within the electronic device (or, alternatively, may allow more active materials such as the metal anode to be included within the battery, depending on the desired performance characteristics of the battery).

In addition to more traditional battery housing shapes (e.g., housings configured for use as coin or button cells, prismatic batteries, cylindrical batteries, etc.), other more non-conventional battery configurations may be created (e.g., custom conformable device inserts, etc.). Because the air electrode 314 may be formed into any of a variety of complex shapes as a result of the binder materials used therein, the housing may be configured to conform to any of a variety of form factors that may be useful for a particular application. The size and shape of such batteries may vary according to any of a number of factors.

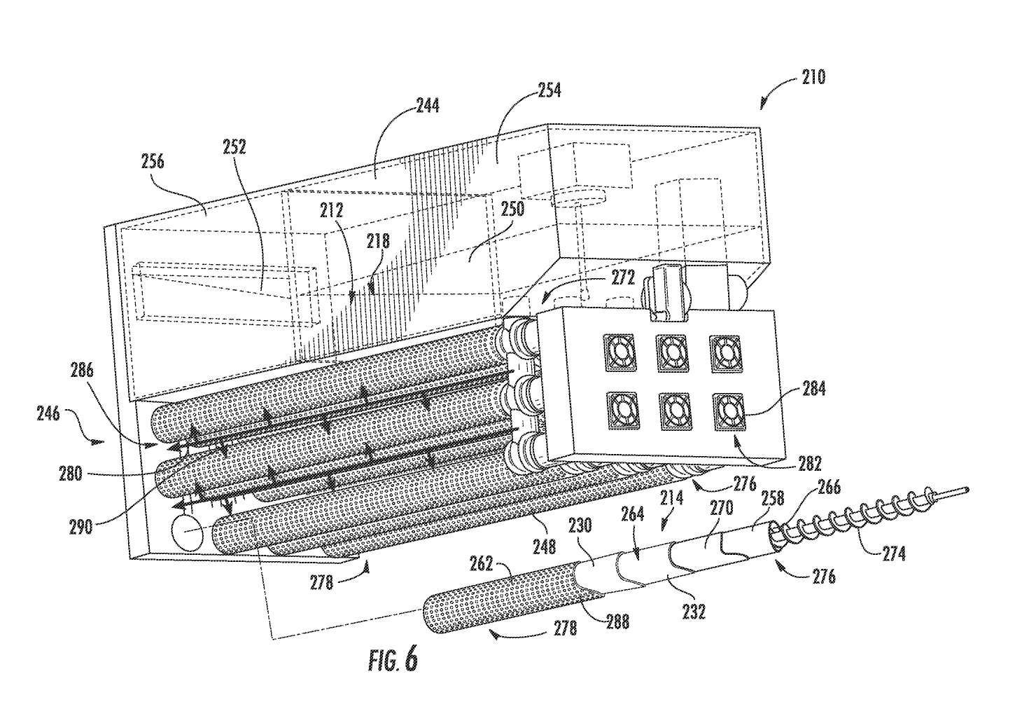

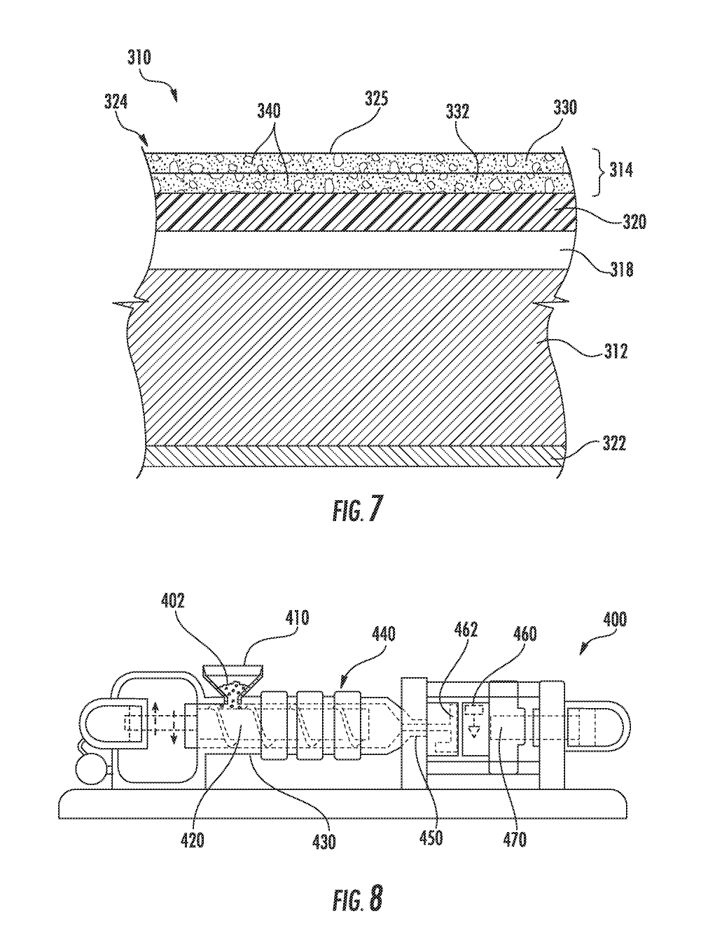

FIG. 8 illustrates an injection molding machine 400 that may be used to form an air electrode or a component thereof according to an exemplary embodiment. The injection molding machine includes a hopper 410 into which a material 402 is fed (e.g., gravity fed). The material 402 may include all of the constituents to be included in the air electrode, including carbon materials, binders, catalysts, and any other materials that will be incorporated into the air electrode (e.g., an ion exchange material, etc.). A feed device 420 such as a screw or augur may direct the material along the length of a barrel 430 that may be heated using a device such as a heater 440. Once the material 402 is melted, it may be directed through a nozzle 450 into a cavity 462 of a mold 460. The nozzle 450 and mold 460 may have any desired configuration, and the cavity 462 within the mold 460 will define the size, shape, and configuration of the molded air electrode. A moveable platen 470 may be configured to open and close to allow removal or ejection of the molded air electrode. The molded air electrode may then be cooled according to any suitable method. Although FIG. 8 illustrates an exemplary embodiment of an injection molding apparatus, it will be appreciated by those reviewing the present disclosure that other configurations may be possible, and are intended to be included within the scope of this disclosure.

According to an exemplary embodiment, an air electrode or a portion or layer thereof may be formed using an extrusion process. Utilizing extrusion methods allows for the creation of air electrodes or portions thereof having complex cross-sectional shapes and provides the ability to work with relatively brittle materials because materials encounter substantially only compressive and shear stresses during extrusion. Extrusion methods may also help achieve excellent surface finishes and increase the binding properties of layers.

Generally, an extrusion process includes pushing or drawing material through a die of the desired cross-section. The extrusion process may be performed with hot material or cold material. According to an exemplary embodiment, the extrusion process is a continuous process in which the air electrodes may be cut to the appropriate length upon or after exit from the extruder. Generally, continuous extrusion processes provide a relatively high level of efficiency (e.g., air electrodes can be produced quickly, low levels of scrap materials are generated, etc.). According to other exemplary embodiments, the extrusion process may be a semi-continuous or a discontinuous process.

According to an exemplary embodiment, the active layer and the gas diffusion layer are co-extruded in one step to produce the air electrode. The materials for the active layer and the gas diffusion layer are mixed with a solvent to form separate pastes. The pastes are then pushed through extruders that are disposed substantially in parallel to form a predefined shape (e.g., flat plates may be used to form a layer having a substantially rectangular cross-section). After being extruded, the layers are disposed adjacent to one another (e.g., sandwiched together) and heat and/or pressure are applied (e.g., via hot extrusion, lamination, calendering, etc.) to couple the active layer to the gas diffusion layer. In one exemplary embodiment, layers formed using an extrusion process may be laminated to bind them into a combined layer. In another exemplary embodiment, layers formed using an extrusion process may be calendered to achieve a desired thickness and/or to link the binders. In some exemplary embodiments, a current collector is provided and disposed between the gas diffusion layer and the air electrode layer before heat and/or pressure are applied (e.g., via calendering, hot pressing, etc.).

According to an exemplary embodiment, a gas diffusion layer is produced using an extrusion process. An active layer is then formed on the gas diffusion layer using a process such as printing, spin coating, etc. (where the active layer is formed of multiple layers, each layer may be formed using the same process or different processes may be used to form one or more of the layers). In some exemplary embodiments, one or more processes including the application of heat and/or pressure are used after the active layer is completed and/or during the air electrode production process.

According to an exemplary embodiment, an active layer is produced using an extrusion process. A gas diffusion layer is then formed on the active layer using a process such as printing, spin coating, etc. (where the gas diffusion layer is formed of multiple layers, each layer may be formed using the same process or different processes may be used to form one or more of the layers). In some exemplary embodiments, one or more processes including the application of heat and/or pressure are used after the gas diffusion layer is completed and/or during the air electrode production process.

According to an exemplary embodiment, an extrusion process may be used to form a cylindrical air electrode for a cylindrical battery (e.g., AA, AAA, a flow/reaction tube (see FIG. 15), etc.). These cylindrical air electrodes may be formed quickly and efficiently. Further, the scrap waste resulting from the production process is minimal.

According to an exemplary embodiment, the extrusion process used to form all or a portion of the air electrode may be a screw-type extrusion process. Such an extrusion process has not previously been used in the formation of air electrodes, since the materials conventionally used to form air electrodes do not have sufficient mechanical strength to allow for the use of such a process while still maintaining suitable conductivity and air diffusion properties. It has been discovered, however, that when binding agents such as PP and/or PE are added in addition to or in place of conventional binders used in air electrodes that the increased mechanical strength of the resulting material may be readily formed into desired shapes using a screw extrusion process.

Screw-type extrusion processes typically include the use of one or more screws (e.g., having a single screw configuration, having a twin screw configuration, etc.) to feed the material/paste for the air electrode through a die having an opening at the end thereof. The material fed through the die may include active layer material, gas diffusion layer material, and/or the material of any other air electrode layer. According to an exemplary embodiment, a screw-type extrusion process includes the use of a material including plastic materials that melt (e.g., PP, PE and/or PTFE), carbons, and catalysts. The material may be provided as a wet or dry material, and the material will melt as a result of applied pressure and heat within the extruder, facilitating the extrusion process. According to one exemplary embodiment, PP and/or PE are used as binding agents because, among other reasons, PE and PP resist becoming brittle during extrusion and have lower melting temperatures than PTFE.

FIG. 9 illustrates an exemplary embodiment of a screw-type extruder 500 that may be used to form an air electrode or a component thereof according to an exemplary embodiment. The extruder 500 includes a hopper 510 into which a material 502 is fed (e.g., gravity fed). The material 502 may include all of the constituents to be included in the air electrode, including carbon materials, binders, catalysts, and any other materials that will be incorporated into the air electrode (e.g., an ion exchange material, etc.). A feed device 520 such as a screw or augur that is driven by a motor 522 may direct the material along the length of a barrel 530. The material 502 enters the barrel 530 through a feed throat 512 and comes into contact with the feed device 520. The rotating screw forces the material 502 forward along the length of the barrel 530 which is heated using one or more heaters 540 positioned along the length of the barrel to the desired melt temperature of the material 502. According to an exemplary embodiment, a heating profile for the barrel 530 may be set in which three or more independent zones gradually increase the temperature of the barrel from the rear (where the material 502 enters) to the opposite end of the barrel 530. This allows the material 502 to melt gradually as it is pushed through the barrel 530 and lowers the risk of overheating which may cause degradation in the material 502. Extra heat is contributed by the pressure and friction within the barrel 530. According to an exemplary embodiment, the heaters 540 can be shut off and the melt temperature maintained by pressure and friction within the barrel 530. Cooling devices such as fans, cooling jackets, fluid cooling devices such as heat exchanges, and the like (not shown) may also be included to maintain the temperature below a desired level.

The molten material 502 leaves the barrel 530 at an end 532 thereof and travels through an optional screen pack to remove contaminants in the melt. The screens are reinforced by a breaker plate 552 (a thick metal puck with many holes drilled through it) since the pressure at this point can be quite high (e.g., greater than approximately 30 MPa). The screen pack/breaker plate assembly also may act to create back pressure in the barrel 530. Back pressure may advantageously provide for relatively uniform melting and proper mixing of the material 502, and how much pressure is generated can be controlled by varying the screen pack composition (the number of screens, their wire weave size, and other parameters).

After passing through the breaker plate 532, the molten material 502 enters a die 560 through a feed pipe 550. The die 560 includes a cavity 562 configured to provide the final size, shape, and configuration to the extruded air electrode (or component thereof). The air electrode 514 can have any desired shape that has a continuous profile. For example, a hollow cylindrical air electrode may be formed, which may be used as an air electrode for a reaction tube of a flow battery such as that described above. Of course, the extrusion process may also be used to form relatively flat sheets of air electrode material as well, in addition to other possible shapes.

According to an exemplary embodiment, the die 560 is configured to allow the molten material 502 to flow evenly from the cylindrical or other profile of the feed pipe 550 to the desired profile of the air electrode. Uneven flow at this stage would produce an air electrode with unwanted stresses at certain points, which may cause undesired warpage upon cooling. The extruded air electrode 514 exits the die 560 through an opening or slot 564 in the end 566 of the die 560 and may then be cooled using any suitable method.

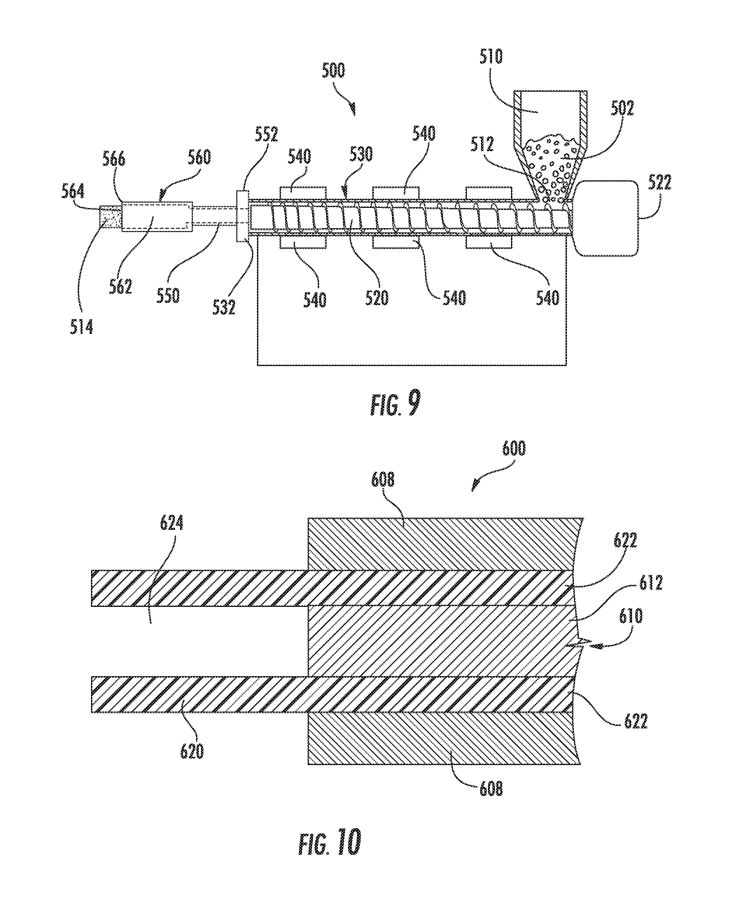

For a coin cell, the extruded air electrode may be produced as a flat sheet of material, after which the air electrode may be cut or stamped from the sheet in any desired shape. For a cylindrical cell where a cylindrical air electrode is desired, a flat sheet may be converted into a hollow cylinder by joining two of the edges of the flat sheet together after the sheet is cut to length or, alternatively (as described with respect to FIG. 10), the cylindrical electrode may be formed directly using a die that produces a hollow cylindrical air electrode. Other possibilities for air electrodes having differing configurations may be used according to other exemplary embodiments.

Although FIG. 9 illustrates an exemplary embodiment of a screw extruder, it will be appreciated by those reviewing the present disclosure that other configurations may be possible, and are intended to be included within the scope of this disclosure.

It should be understood that the screw extrusion process may be used to form air electrodes having any of a variety of configurations. For example, FIG. 10 illustrates a portion of a screw-type extruder 600 according an exemplary embodiment that is configured to produce an air electrode 620 having a hollow cylindrical configuration. A material 622 that has been melted as described above with respect to FIG. 9 is pushed into and through a slot 610 of an nozzle 608 of the extruder 600. A member 612 is located within the slot 610 such that a hole 624 (e.g., opening, aperture, channel, etc.) is formed through the middle of the material 622 as it cools, forming the hollow cylindrical air electrode 620. While the slot is shown having a circular cross-section, the slot may be configured to have any number of cross-sections according to other exemplary embodiments. According to other exemplary embodiments, the material 622 may be used to form an active layer or a gas diffusion layer of the air electrode 620.

An additional process that may be utilized in the formation of air electrodes is a slot die extrusion process.

Generally, slot die extrusion includes providing a current collector and one or more pastes or slurries intended to be fed through an extruder. Both the mesh current collector and the pastes or slurries are simultaneously fed through the extruder. The extruded metal-air battery components are then calendered to compact the active materials to the current collector and/or to adjust the thickness. In one exemplary embodiment, the mesh current collector is placed through an opening (e.g., slot, aperture, etc.) at a central location of the extruder.

Referring to FIG. 11, a slot die extruder 700 is shown forming a complete air electrode 702 in a continuous process according to an exemplary embodiment. The air electrode 702 includes an active layer 704, a gas diffusion layer 706, and a current collector 708. The slot die extruder 700 is shown including an inlet 710, an outlet 712, and one or more rollers 714 for calendaring. A first paste or slurry 720 is provided that is intended to be formed into the gas diffusion layer 706, and a second paste or slurry 722 is provided that is intended to be formed into the active layer 704. The current collector 708 is placed into the extruder 700 (e.g., at a generally central location). The first paste or slurry 720 is placed into the inlet 710 of the extruder 700 to one side of the current collector 708 and the second paste or slurry 722 is placed into the inlet 710 of the extruder 700 to the other side of the current collector 708. The pastes or slurries 720, 722 and the current collector 708 are forced (e.g., pushed, moved, pulled, etc.) from the inlet 710 toward the outlet 712 of the extruder 700. The resultant air electrode 702 is shown having the current collector 708 disposed between the active layer 704 and the gas diffusion layer 706. According to some exemplary embodiments, the resultant air electrode is subsequently sintered at a temperature of approximately 200-320° C. in a press at a pressure of approximately 3000 psi. According to other exemplary embodiments, however, the air electrode may be sintered at any suitable temperature in a press at a pressure of approximately 1000 to 5000 psi. In some exemplary embodiments, the rollers for calendaring are not used in a slot die extrusion process. In some exemplary embodiments, other processes involving the application of heat and/or pressure are used during and/or after the slot die extrusion process. It should be noted that the slot die extrusion steps may be defined or grouped in other manners.

According to an exemplary embodiment, slot die extrusion is used to produce a gas diffusion layer including a current collector disposed therein. The current collector is disposed into an inlet of a slot die extruder between a first portion and a second portion of a gas diffusion layer slurry or paste. In one exemplary embodiment, the slurries or pastes on either side of the current collector are substantially the same (e.g., have substantially the same composition, etc.). In another exemplary embodiment, the slurries or pastes on either side of the current collector are different (e.g., the slurry portion intended to form the outside of the gas diffusion layer, e.g., the side/portion proximate to the air holes, may include more binder materials than the inside, providing for an improved oxygen diffusion rate, improved resistance to delamination, and/or improved prevention of electrolyte leakage through the gas diffusion layer). In some exemplary embodiments, the current collector may be disposed substantially in the center of the two extruded gas diffusion layer portions. According to other exemplary embodiments, the current collector is disposed closer to one of the side of the gas diffusion layer than the other.

Disposing the current collector within the gas diffusion electrode provides a number of benefits. First, this position substantially avoids exposing the current collector to the air side of the air electrode, reducing sealing challenges. Second, this position substantially avoids exposing the current collector on the active layer side of the air electrode, reducing delaminating issues for the air electrode.

According to an exemplary embodiment, slot die extrusion is used to produce an active layer including a current collector disposed therein. The current collector is disposed into an inlet of a slot die extruder between a first portion and a second portion of an active layer slurry or paste. In one exemplary embodiment, the slurries or pastes on either side of the current collector are substantially the same. In another exemplary embodiment, the slurries or pastes on either side of the current collector differ. For example, a paste composition with catalysts and binders suited predominantly for the oxygen evolution reaction can be extruded to one side of the mesh and a composition with catalysts and binders suited predominantly for the oxygen reduction reaction can be extruded to the other side of the mesh, providing a bifunctional air electrode with improved functionality because the oxygen evolution and the oxygen reduction reactions are separated into two different layers. In some exemplary embodiments, the current collector may be disposed substantially in the center of the two extruded active layer portions. In other exemplary embodiments, the current collector is disposed closer to one of the end of the active layer than the other.

According to an exemplary embodiment, slot die extrusion is used produce an air electrode including a current collector disposed therein, the current collector being disposed to between the active layer and the gas diffusion layer. When forming the air electrode, the slurry or paste to one side of the current collector includes material for the active layer, and the slurry or paste to the other side of the current collector includes material for the gas diffusion layer.

Injection molding and extrusion processes (e.g., screw extrusion, slot die extrusion) may be used alone or in combination with other processes involving the application of heat and/or pressure (e.g., calendaring, laminating, hot pressing, sintering, etc.) to the layers, which may be used to increase the binding properties of the layers. For example, by providing for cross-linking of the binders, these methods may increase the chemical and mechanical stability of the air electrode. In addition to helping to bind materials together, some of these processes (e.g., calendaring) may be used to smooth out a paste and/or to adjust the thickness of a layer of material. In some exemplary embodiments, a series of hard pressure rollers are used to calender and/or laminate one or more air electrode layers produced using an extrusion process. This calendering and/or lamination may take place at the end of an on-line process, or at another point in the process. It should also be noted that treatments involving the application of heat and/or pressure may also be used with air electrodes or layers thereof formed using processes other than an extrusion process (e.g., spray printing, spin coating, etc.).

As described above, one or more of the primary layers of the air electrode (e.g., the active layer, the gas diffusion layer, and the oxygen evolution layer) may be formed of a plurality of sublayers according to an exemplary embodiment, and such sublayers may be formed using any of a variety of processes. The methods described below may provide a number of advantages in forming an air electrode. For example, the methods provide the ability to produce relatively thin (e.g., thin film) sub-layers, and also to improve the uniformity of the sub-layers produced. The methods also may provide the ability to exercise a significantly greater level of control over the amount, type, and/or positioning of certain materials within the air electrode generally along the stacking axis. The methods may also provide the ability to control the amount, type, and/or positioning of certain elements within a given sub-layer of the air electrode. Control within a given sub-layer can be achieved using a spray printing method (e.g., ink-jet-type spray printing). Methods including screen printing and/or masking can also be used.

In addition to the foregoing advantages, the processes may also allow certain materials to be purposefully included or excluded at certain locations (e.g., portions, in sub-layers, etc.) of the air electrode; the amount certain materials can be increased or decreased at certain locations; and the relative positions of certain materials can be controlled. As the presence, absence, amount, and/or position of certain materials can affect the performance, functionality and/or potential uses of the air electrode, the ability to control the composition and position of each sub-layer formed during a multi-layer air electrode production process provides improved control the functionality, performance, and potential uses of a portion of a metal-air battery and/or the air electrode thereof. For example, the production methods provide the ability to achieve multi-layer air electrode constructions with variations of the pore size, hydrophobicity, conductivity, catalyst loading, composition, additives, etc. through the air electrode.

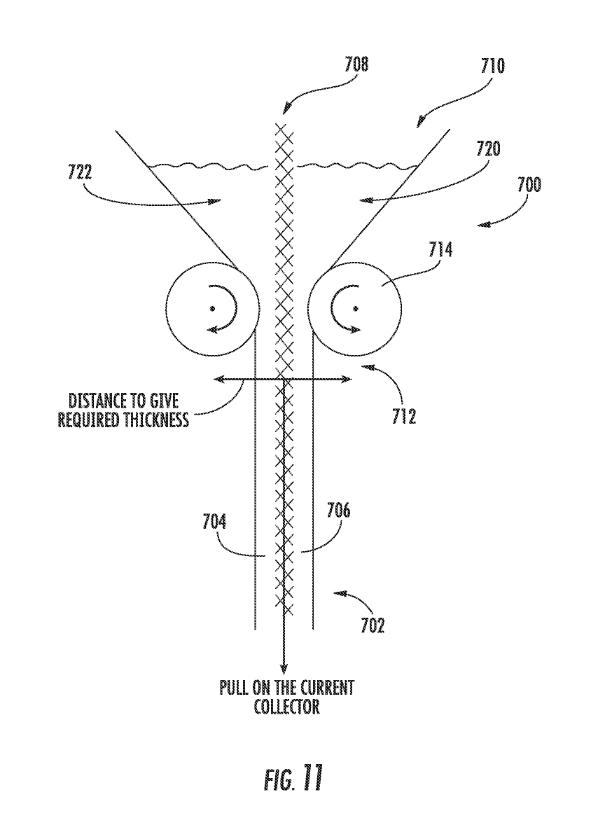

Referring to FIGS. 12-14, a multi-layer air electrode 810 including a gas diffusion layer 812 having a plurality of sublayers 814 and an active layer 816 having a plurality of sublayers 818 is shown according to an exemplary embodiment. Using one or more of the multi-layer production processes described below (e.g., screen printing, spray printing, spin coating, etc.), each sublayer (or portion thereof) may be formed thinner than layers that may be formed using conventional air electrode production processes (e.g., using calendaring and lamination), which typically have thicknesses greater than 100 micrometers (as defined along the z-direction indicated in FIG. 12). Sublayers formed using the below-described printing and coating processes may be thin films (e.g., having thicknesses less than 100 micrometers, etc.).

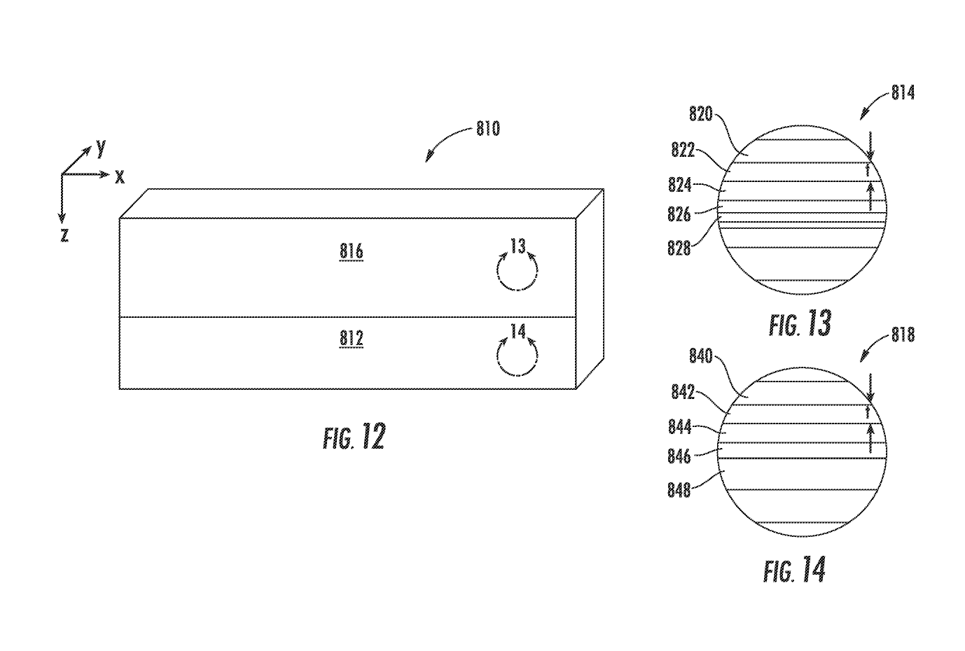

Referring to FIG. 13, a sectional view of the plurality of sublayers 814 of the gas diffusion layer 812 is shown in more detail including a first sublayer 820, a second sublayer 822, a third sublayer 824, a fourth sublayer 826, and a fifth sublayer 828, etc. according to an exemplary embodiment. According to one exemplary embodiment, all of the sublayers 814 of the gas diffusion layer 812 are thin films. According to other exemplary embodiments, less than all of the sublayers are thin films (e.g., one of the sublayers is a thin film, all but one of the sublayers is a thin film, four of the sublayers are thin films, etc.).

Referring to FIG. 14, a sectional view of the plurality of sublayers 818 of the active layer 816 is shown in more detail including a first sublayer 840, a second sublayer 842, a third sublayer 844, a fourth sublayer 846, and a fifth sublayer 848, etc. according to an exemplary embodiment. According to one exemplary embodiment, all of the sublayers 818 of the active layer 816 are thin films. According to other exemplary embodiments, less than all of the sublayers are thin films (e.g., one of the sublayers is a thin film, all but one of the sublayers is a thin film, four of the sublayers are thin films, etc.).

Referring to FIGS. 13 and 14, each layer of the plurality of sublayers 814 of the gas diffusion layer 812 and the plurality of sublayers 818 of the active layer 816 is shown having a different thickness “t,” defined generally along the stacking axis (shown as the z-axis in FIG. 12) of the air electrode (or portion thereof). According to some exemplary embodiments, the thicknesses of some layers may be the same while others differ. According to other exemplary embodiments, the thicknesses of the layers may all be the same, may vary at certain locations of a sublayer, etc. According to other exemplary embodiments, the thicknesses of the sublayers in a primary layer or a portion thereof may get progressively larger or smaller. The thickness of a given sublayer can depend on the composition of that layer, the position of that layer in the air electrode, the layers adjacent to that layer, the function of that layer, etc.

Each sublayer is formed by applying coating material (e.g., solution, suspension, ink, etc.) to a substrate. The substrate may be a flat surface, a curved surface, or an irregularly shaped surface. According to one exemplary embodiment, the substrate is a previously formed layer of the air electrode (e.g., the gas diffusion layer, the active layer, a sublayer of the gas diffusion layer or the active layer, etc.). According to another exemplary embodiment, the substrate may be another metal-air battery component (e.g., a housing). According another exemplary embodiment, the substrate is a glass plate. According to another exemplary embodiment, the substrate is a plastic film. According to another exemplary embodiment, the substrate is a metallic film. According to some exemplary embodiments, the substrate is porous and intended to facilitate removal of the substrate without substantially damaging the layers formed on it. According to some exemplary embodiments, the substrate is non-porous. According to other exemplary embodiments, the substrate may be any support surface suitable for supporting a sublayer during formation.

According to an exemplary embodiment, the coating material is a liquid. The liquid includes particles to be distributed onto the substrate. According to other exemplary embodiments, the coating material may also include, but is not limited to, a slurry or a paste.

It should be noted that a single sublayer may be formed using a single coating material application or a plurality of coating material applications, as discussed in more detail below. The coating material is generally retained (e.g., stored, held, deposited, etc.) in one or more reservoirs (e.g., receptacles, bags, pouches, cartridges, reserves, repositories, containers, etc.) and then applied to one or more surfaces of a substrate. Each coating material used to form a sublayer may be applied (e.g., distributed, dispersed, delivered, disseminated, dispensed, provided, served, etc.) from a single reservoir or from multiple reservoirs. Wherein multiple reservoirs are used to apply a sublayer, the reservoirs may each contain the same coating material components, may each contain different coating material components, or some reservoirs may contain the same coating material components while others contain different coating material components. It should also be noted that a single sublayer may include two or more portions each having a different composition (i.e., the composition within the sublayer may vary, for example, in the x-y plane indicated in FIG. 12).

The composition of each sublayer may be varied by changing (e.g., adjusting, substituting, replacing, altering, modifying, etc.) the composition of the coating material applied to form the sublayer. The composition of each sublayer may also be varied by removal of material elements in the original coating material after application (e.g., by evaporation, by leaching, etc.) and/or by changing the sequence in which a plurality of coating materials are applied to form the sublayer.

It should be noted that the properties of the coating materials used to form the sublayers may vary depending on the type of printing or coating process used and/or the desired thickness of the resultant sublayer. For example, the inclusion and/or amount of a water-based suspension including additives to prevent segregation of the deposited powder materials in the coating material may be varied. In another example, the temperature and/or length of time heat is applied to a coating material after it has been applied to a substrate may be varied.

Referring to FIGS. 13 and 14, the composition of each sublayer may vary according to an exemplary embodiment. In another exemplary embodiment, the composition of each sublayer is substantially similar. In another exemplary embodiment, the compositions of the sublayers may alternate. For example, every other sublayer may have the same composition. In some exemplary embodiments, two or more sublayers having substantially similar compositions are grouped together (e.g., are disposed adjacent to one another). In some exemplary embodiments, two or more sublayers having substantially similar compositions are spaced a distance from each other (e.g., not disposed adjacent to one another). In some exemplary embodiments, two or more groupings of sublayers have substantially similar compositions. In some exemplary embodiments, two or more groupings of sublayers have compositions that differ. In some exemplary embodiments, all sublayers are grouped with other sublayers having a substantially similar composition. In some exemplary embodiments, some sublayers are included in groupings of sublayers having substantially similar compositions while others sublayers are not grouped with sublayers having substantially similar compositions. According to still other exemplary embodiments, the composition of the sublayers may be varied in substantially any desirable manner. It should be noted that sublayers having substantially identical compositions may be applied in different manners (e.g., from two reservoirs having the same coating material components, from two reservoirs containing different coating material components which combine to result in the composition of the resultant sublayer, etc.).

A number of different methods may be used to form the sublayers, several of which are described below. In producing an air electrode, one or more of these processes may be used to form the various sublayers. Additionally, as described above, the processes described below may be used in conjunction with layers that have been formed using other methods described herein (e.g., injection molding, extrusion such as screw extrusion, slot die extrusion, etc.), such as by applying the sublayers formed using the methods described below onto the previously-produced other layer (e.g., sublayers of an air electrode layer may be formed using the processes below over a gas diffusion layer that has been manufactured using an injection molding or screw extrusion process, where the gas diffusion layer includes, for example, PE and/or PP to provide enhanced mechanical strength for the gas diffusion layer—in such a case, the sublayers of the active layer may or may not include PE or PP, alone or in combination with PTFE or another binder material).

According to an exemplary embodiment, printing methods (e.g., screen printing, spray printing, etc.) may be used to form the sublayers. Sublayers produced using printing methods are generally thin films (e.g., having a thickness of approximately 0.5 μ-400 μm). Also, these printing methods can be used to create textured sublayers.

An air electrode or one or more sublayers thereof may be produced using a screen printing method. Screen printing provides the ability to apply thin sublayers to a substrate and the option to texture these sublayers. Screen printing also provides for a high degree of control over the thickness of each sublayer. Screen printing methods (a.k.a., silk screening, serigraphy, etc.) generally include forming a sublayer by applying a coating material to a substrate using a screen stencil.

The screen stencil includes a mesh and a coating-blocking material that allows for patterning of the sublayer. The coating-blocking material blocks (covers, overlays, etc.) portions of the mesh to form a stencil. The coating material for the sublayer is applied and moved (e.g., transferred, forced, pumped, etc.) through the portions (e.g., areas, regions, etc.) of the mesh not blocked off by the coating-blocking material (i.e., open portions). According to one exemplary embodiment, a roller or squeegee is moved across the screen stencil, forcing or pumping the coating material past the mesh in the open portions. According to other exemplary embodiments, other devices or methods for moving the coating material through the open portions of the screen stencil may be used.

The mesh is generally a semi-permeable or porous barrier made up of numerous attached (e.g., interconnected, bonded, etc.) or woven strands. The strands may be strands of metal, fiber, and/or other flexible/ductile materials. Generally, the mesh is any material suitable for allowing for transport of a coating material.

The coating-blocking material is intended to prevent the coating material from moving through certain portions of the mesh. The coating-blocking material is typically an impermeable material. The stencil formed by the portions of the screen that are blocked off by the coating-blocking material is a negative of the image to be printed. That is, the open portions of the screen correspond to the locations where the coating material will be applied to the substrate to form the sublayer. Conversely, the portions of the screen blocked off by the coating-blocking material result in “blanks” or blank portions (e.g., apertures, voids, openings, locations where the coating material is not deposited, etc.) in the resultant sublayer. By blanking certain portions of the substrate, textures and/or patterns having desired configurations can be produced.

According to an exemplary embodiment, a screen is provided and disposed generally above a substrate. A fill bar (a.k.a., a floodbar) is used to fill the open portions of the screen with the coating material. The fill bar begins disposed at one end of the screen and behind a reservoir of the coating material. After ensuring the screen is not initially in contact with the substrate, a force is applied to pull the fill bar in order to move the fill bar across the screen, filling the open portions of the screen with coating material. This action also causes the fill bar to be moved to an opposing end of the screen. A squeegee or similar device is subsequently used to move the mesh down to the substrate and then moved across the screen (e.g., from one end of the screen to an opposing end of the screen) to move (e.g., pump or squeeze) by capillary action the coating material from the open portions of the screen to the substrate. The coating material is moved in a controlled and prescribed amount (i.e., the coating thickness is substantially equal to the thickness of the mesh and or the stencil, and, accordingly, the thickness of the deposited coating can be varied by varying the thickness of the mesh and/or stencil). Typically, as the squeegee is moved across the screen, the tension of the mesh pulls the mesh up away from the substrate (i.e., the mesh snaps-off), leaving the coating material on the substrate surface to form the sublayer. It should be noted that this method may be varied depending on the coating composition and/or the position of the sublayer formed in the air electrode. According to other exemplary embodiments, any reservoir suitable for distributing coating material and filling the open portions of a screen may be used in lieu of a fill bar.

According to an exemplary embodiment, a plurality of successive sublayers are produced using a screen printing method. For example, according to one embodiment, a first coating material is screen printed onto a substrate (e.g., a porous or non-porous support surface, as described above) to form a first sublayer of the air electrode, after which a second coating material is screen printed onto the first sublayer to form a second sublayer of the air electrode. A third coating material is then screen printed onto the second sublayer to form a third sublayer of the air electrode. Additional sublayers may continue to be formed using a screen printing process. It should be noted that the screen stencil used for each application of coating material may be varied (and that any desired number of layers may be produced using this method).

According to an exemplary embodiment, a flat-bed screen printing press is utilized during the screen printing processes. According to other exemplary embodiments, a cylinder or rotary screen printing press is utilized. Generally, the type of press utilized depends on the configuration of the air electrode being produced.

According to an exemplary embodiment, the screen printing process or technique is automated. Automation provides for high speed production of air electrodes or layers thereof.

According to another exemplary embodiment, an air electrode or one or more layers thereof may be produced using a spray printing method (e.g., spray painting, spray coating, etc.). Spray printing provides the ability to apply thin film sublayers of material to a substrate and the option to texture these sublayers. A high degree of control can also be exercised over the thickness of these sublayers. Spray printing also provides the ability to efficiently include gradients of certain material components (e.g., a catalyst, the amount and type of a binder, the support materials, an electrolyte in the form of an OH⁻ conductive polymer, etc.) through the air electrode. This can be accomplished, for example, by gradually adjusting the powder mixture concentrations in the coating material, where the coating material includes powder mixture and solvent components. While gradients can also be produced using a screen printing process, a spray printing process can typically produce a gradient of a material component even more efficiently than a screen printing process.

A spray printing method generally includes application of a coating material to a substrate by spraying a coating material through an atmosphere (e.g., air, argon (Ar), nitrogen (N₂), etc.) onto a substrate. According to one exemplary embodiment, the spray printing method may utilize or be a variant of an ink jet material deposition process Ink jet-type deposition processes have a number of advantages, including the ability to apply coating materials with great precision.

According to an exemplary embodiment, a spraying device utilized for spray printing air electrode layers includes one or more nozzles and a device or system for spraying the coating material (e.g., compressed gas, etc.). The consistency and texture of the coating can be changed by varying the shape and size of a nozzle and/or one or more of the spray holes thereof.

An exemplary method of using a spray printing process will now be described according to an exemplary embodiment. The substrate to receive the coating material is disposed on a support surface (e.g., stand, fixture, rollers, etc.). A spraying device is positioned relative to the substrate (e.g., within millimeters or centimeters of the substrate). The coating material is applied onto the desired side, surface, or portion of the substrate. The spraying device may be an air gun, an ink cartridge droplet dispenser (e.g., similar to those used in ink jet printing), or any other device suitable for spraying a coating material through an atmosphere toward a substrate to form a layer. The sublayer formed by applying the coating material may be smooth or textured. The texture of the resulting sublayer may be varied by altering the position of the spray device, altering the position of the support surface for the sample, changing or adjusting a nozzle, changing the movement of the spraying device, turning the spraying device on and off, etc. The textures may have a magnitude generally within the range of nanometers to centimeters. The textures may include, but are not limited to, channels, dots or three-dimensional networks, spherical features, cylindrical features, rectangular features, and/or a random distribution of material over a surface.

According to an exemplary embodiment, a plurality of successive sublayers are produced using a spray printing method. For example, according to one exemplary embodiment, a first coating material is spray printed onto a substrate (e.g., a plastic film, a porous film, a metal film or layer, etc.) to form a first sublayer of the air electrode, after which a second coating material is spray printed onto the first sublayer to form a second sublayer of the air electrode. A third coating material is spray printed onto the second sublayer to form a third sublayer of the air electrode using a screen printing method. Additional sublayers may continue to be formed using a spray printing process. It should be noted that the coating composition, thickness, and/or texture may be varied with each application (and that any desired number of layers may be produced using this method).

According to an exemplary embodiment, a piezoelectric ink-jet-type spray printing air electrode production process is used to form a sublayer of an air electrode. A piezoelectric material is included in a coating-material-filled reservoir behind a nozzle. Applying a voltage to the piezoelectric material causes the piezoelectric material to change shape and/or size. The change in the shape and/or size of the piezoelectric material creates a pressure pulse in the coating material, forcing a portion (e.g., droplet, etc.) of the coating material from the nozzle. This process may be continuous, discontinuous, or semi-continuous.

According to an exemplary embodiment, a thermal ink-jet-type spray printing air electrode production process may be used to form a sublayer of an air electrode.

According to an exemplary embodiment, a spray gun is used to form a sublayer in an automated process. The spray gun includes a gun head, which is attached to a mounting block and delivers a stream of the coating. During application of the coating to the substrate, the spray gun may move relative to the substrate, the substrate may move relative to the spray gun, and/or both the substrate and the spray gun may move relative to each other.

According to another exemplary embodiment, one or more layers of an air electrode may be produced using a spin coating method. Spin coating provides the ability to deposit a substantially uniform layer of material onto a substrate and provides for a high degree of control over the thickness of each sublayer. Spin coating also provides the ability to form sublayers on irregular surface (e.g., cylindrical, star-shaped, etc.). It is believed that this method can also be utilized to include (e.g., add, integrate, layer, etc.) novel materials (e.g., ion selective material, ionic liquids, siloxane-type material, etc. discussed in more details below) into a base structure of an air electrode and/or to include catalyst layers from a solution. It is also believed that the above-described printing methods and variations thereof can be utilized to add novel materials.

Spin coating methods generally include application of a coating material to a smooth substrate. The coating material is typically applied in excess (e.g., an amount greater than needed for the resultant layer). The substrate is then rotated, which causes the coating material to spread across the surface of the substrate, with the excess expelled (e.g., discharged, flung off, cast off, etc.) outward from the edges of the substrate.

The thickness of the resultant layer can be controlled by controlling the rate at which the spin coater (a.k.a., spinner, etc.) is rotated, the composition of the coating material, and/or the concentration of the solution and the solvent. Typically, the greater the length of time that the substrate is rotated, the thinner the resultant layer will be. For example, for a period of time, the coating material will continue to be expelled from the substrate as the substrate is rotated. The substrate may be rotated for only a portion of this period to form a thicker layer or may be rotated for the entire period to form a thinner sublayer. Also, when the solvent of the solution is volatile, it evaporates as the substrate rotates. Further, when the solvent is volatile, rotating the substrate at higher angular speeds typically results in thinner layers.

An exemplary method for producing a spin coated layer of an air electrode will now be described. Although the method below includes four steps, it should be noted that the steps may be grouped or classified in other manners. First, a coating material is deposited onto a substrate in excess (i.e., using more than is needed/required to form the desired sublayer). In one exemplary embodiment, the solution is deposited by using a nozzle to pour or spray the solution onto the surface of the substrate. According to other exemplary embodiments, the solution may be deposited in any suitable manner. Second, the substrate is rotated, gradually accelerating up to its final, desired, angular speed. Third, the substrate is rotated at substantially a constant rate, because fluid viscous forces generally dominate the fluid thinning behavior. Fourth, the substrate is rotated until a desired amount of the solvent evaporates. During this step, evaporation generally dominates the coating thinning behavior. Alternatively, one or more of steps 2-4 can be grouped together.

Spin coating allows production of thin film sublayers that are very thin. According to one exemplary embodiment, a layer deposited by spin coating may have a thickness of less than 10 μum. According to other exemplary embodiments, the sublayer thicknesses may be within a range of approximately 400 μm to several mm.

According to an exemplary embodiment, an active layer is spin coated onto a gas diffusion layer. The gas diffusion layer may be formed by any method disclosed herein (e.g., screen printing, spray printing, spin coating, extrusion, injection molding, combinations thereof, etc.). The active layer may be formed during a single, continuous application of coating material using spin coating or from multiple, discontinuous (or semi-continuous) applications of coating materials using spin coating. Alternatively, the gas diffusion layer may be spin coated onto an active layer, the active layer being formed by any method disclosed herein.

According to an exemplary embodiment, a spin coating process may be used to form a single sublayer of an air electrode. According to another exemplary embodiment, a spin coating process may be used to form a plurality of sublayers of an air electrode. According to still another exemplary embodiment, a primary layer of an air electrode can be formed utilizing a single, continuous spin coating process.

According to an exemplary embodiment, a method of producing an air electrode includes spin coating both an active layer and a gas diffusion layer. Both the active layer and the gas diffusion layer are formed by spin coating several sublayers onto a substrate (e.g., the battery housing, a previously applied sublayer, etc.). In one exemplary embodiment, the air electrode production and the battery assembly can be combined into one step/line (i.e., separate lines for air electrode production and assembly are not a requirement). This can provide for improved control of the overall tolerances because one avoids having to sum the standard deviations of the air electrode thicknesses from both parts of the production process. According to some exemplary embodiments, the need for a secondary production process involving the application of heat and/or pressure (e.g., calendaring, lamination, etc.) is eliminated.

According to an exemplary embodiment, a spin coating process is used to apply a selective film on a gas diffusion layer and/or an active layer of an air electrode. According to another exemplary embodiment, a spin coating process is used to apply a catalyst layer on an active layer.

According to another exemplary embodiment, one or more layers of an air electrode may be produced using a dip coating method. Dip coating provides the ability to deposit a relatively thin layer of an air electrode. According to some exemplary embodiments, the dip-coated layer is a thin film.

According to an exemplary embodiment, dip coating a substrate to form a layer involves immersing a substrate in a coating material disposed in a receptacle (e.g., tank, bowl, etc.). The substrate remains in the receptacle for a period of time, providing the coating material an opportunity to form a layer about/on the substrate. Finally, the substrate is withdrawn from the receptacle. Alternatively, the receptacle can be drained of the coating material. Generally, the longer the substrate is disposed in the coating material, the thicker the resultant layer will be.

According to an exemplary embodiment, hot stamping or welding may be used for housings utilizing thicker plastic materials. In some exemplary embodiments, the air electrode may be welded or hot stamped directly to the housing.

Various combinations of materials, structures, application methods, methods of manufacture, and applications discussed herein may be used within the scope of this disclosure. Also, while the description included herein is primarily directed to batteries, the concepts disclosed also apply to fuels cells and other electrochemical conversion devices having desired configurations.

The metal-air batteries described herein may be used singularly or in combination, and may be integrated into or with various systems or devices to improve efficiency, address energy demands, etc. The metal-air batteries described herein may be used in a wide range of applications. For example, the battery may be used in large systems and devices (e.g., power levels in the kW range), where improving environmental aspects (e.g., the environment external to the battery and the effect of this environment on the chemical reaction within the battery) of the metal-air battery may provide for significant gains in performance (e.g., energy conversion and storage at high efficiency). Also, the battery may be used in smaller systems (power levels in the W range), where advances in consumer electronics provide opportunities for energy conversion and storage provided in a desirable size and having a relatively long lifespan

Coin cells, prismatic cells, and cylindrical cells such as those described herein may be used in any application where such batteries may find utility, including, for example, hearing aids, headsets (e.g., Bluetooth or other wireless headsets), watches, medical devices, and other electronic devices such as (but not limited to) cameras, portable music players, laptops, phones (e.g., cellular phones), toys, portable tools. Metal-air flow batteries can provide energy storage and conversion solutions for peak shaving, load leveling, and backup power supply (e.g., for renewable energy sources such as wind, solar, and wave energy). The flow batteries may allow for the reduction of energy generation related emissions (e.g., greenhouse gases), and may also be used in a manner intended to improve the efficiency of the public utility sector. Flow batteries may also be used in for providing backup power, for example, for residential or commercial buildings such as homes or office buildings. In the automotive context, metal-air flow batteries may also be used to provide motive power for an electric vehicle (e.g., a hybrid-electric vehicle, plug-in hybrid electric vehicle, pure electric vehicle, etc.), to provide backup power for the battery (e.g., as a range-extender), to provide power for other vehicle electric loads such as the electronics, GPS/navigation systems, radios, air conditioning, and the like within the vehicle, and to provide for any other power needs within the vehicle (it should be noted that metal-air batteries having prismatic, cylindrical, or other configurations may also be used to provide power in the foregoing vehicle applications, for example, where a number of batteries are used in conjunction with each other to form a battery pack, module, or system).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions.

What is claimed is:

1. A method of producing an air electrode for a metal-air battery, the method comprising:
forming at least a portion of the air electrode using a process selected from the group consisting of an injection molding process and a screw extrusion process.

2. The method of claim 1, wherein said forming comprises forming a gas diffusion layer of the air electrode using an injection molding process or a screw extrusion process, wherein the gas diffusion layer comprises at least one of polyethylene and polypropylene.

3. The method of claim 2, wherein the gas diffusion layer further comprises polytetrafluoroethylene.

4. The method of claim 1, wherein said forming comprises forming an active layer of the air electrode using an injection molding process or a screw extrusion process, wherein the gas diffusion layer comprises at least one of polyethylene and polypropylene.

5. The method of claim 4, wherein the active layer further comprises polytetrafluoroethylene.

6. The method of claim 1, wherein the air electrode comprises an active layer and a gas diffusion layer, and the method comprise forming the active layer using an injection molding process or a screw extrusion process, the active layer comprising polytetrafluoroethylene but not polyethylene or polypropylene.

7. The method of claim 1, further comprising forming another portion of the air electrode using a process selected from the group consisting of screen printing, spray printing, spin coating, and dip coating.

8. The method of claim 7, wherein the other portion of the air electrode comprises a plurality of sublayers, wherein at least one of the sublayers includes a different binder composition that at least one of the other sublayers.

9. The method of claim 8, wherein the other portion of the electrode is an active layer for the air electrode and the method comprises forming a gas diffusion layer of the air electrode using an injection molding process or a screw extrusion process.

10. The method of claim 1, wherein said forming comprises forming a gas diffusion layer for the air electrode using an injection molding or an extrusion process and forming an active layer for the air electrode using a separate process.

11. The method of claim 1, wherein the air electrode is configured for use in a reaction tube for a flow battery.

12. The method of claim 1, wherein the air electrode is configured for use within one of a coin cell, a prismatic battery, or a cylindrical battery.

13. The method of claim 1, wherein said forming at least a portion of the air electrode comprises injection molding the air electrode such that it is configured for use as a portion of a housing of the metal-air battery.

14. A method of producing an air electrode for a metal-air battery, the method comprising:
forming a gas diffusion layer for the air electrode using a screw extrusion process or an injection molding process, the gas diffusion layer comprising at least one material selected from the group consisting of polyethylene and polypropylene; and
adding an active layer to the gas diffusion layer.

15. The method of claim 14, wherein adding an active layer to the gas diffusion layer comprises forming at least a portion of the active layer over the gas diffusion layer using a process selected from the group consisting of printing, spraying, spin coating, and dip coating.

16. The method of claim 15, wherein the active layer comprises a plurality of sublayers, and each of the sublayers are formed using a process selected from the group consisting of printing, spraying, spin coating, and dip coating.

17. The method of claim 16, wherein the gas diffusion layer comprises at least one binder selected from the group consisting of polyethylene and polypropylene.

18. The method of claim 17, wherein the gas diffusion layer further comprises polytetrafluoroethylene.

19. The method of claim 18, wherein the active layer comprises polytetrafluoroethylene and at least one of the sublayers of the active layer does not include polyethylene or polypropylene.

20. The method of claim 15, further comprising coupling a current collector to the gas diffusion layer before adding the active layer.

21. The method of claim 14, wherein adding an active layer to the gas diffusion layer comprises forming the active layer using a screw extrusion process or an injection molding process and subsequently coupling the active layer to the gas diffusion layer.

22. The method of claim 21, wherein the gas diffusion layer comprises at least one binder selected from the group consisting of polyethylene and polypropylene.

23. The method of claim 22, wherein the gas diffusion layer further comprises polytetrafluoroethylene.

24. The method of claim 21, further comprising providing a current collector between the active layer and the gas diffusion layer before coupling the active layer to the gas diffusion layer.

25. The method of claim 14, wherein adding an active layer to the gas diffusion layer comprises forming the active layer using a slot die extrusion process and subsequently coupling the active layer to the gas diffusion layer.

26. An air electrode for a metal-air battery comprising:
a gas diffusion layer comprising at least one material selected from the group consisting of polyethylene and polypropylene; and
an active layer that does not include polyethylene or polypropylene.

27. The air electrode of claim 26, wherein the gas diffusion layer further comprises polytetrafluoroethylene.

28. The air electrode of claim 26, wherein the active layer further comprises polytetrafluoroethylene.

29. The air electrode of claim 26, wherein the active layer comprises a plurality of sublayers.

30. The air electrode of claim 29, wherein a first sublayer of the plurality of sublayers has a first composition and a second sublayer of the plurality of sublayers has a second composition, the first composition differing from the second composition.

31. The air electrode of claim 26, wherein the gas diffusion layer has a curved surface and the active layer is located over the curved surface.

32. The air electrode of claim 26, wherein the gas diffusion layer has a configuration that is intended to allow the air electrode to function as a portion of a metal-air battery housing.
